(19) United States
(12) Patent Application Publication
(10) Pub. No.: US 2025/0350679 A1
(43) Pub. Date: Nov. 13, 2025

(54) ELECTRONIC DEVICE COMMUNICATING WITH DISPLAY DEVICE, AND CONTROL METHOD THEREFOR

(71) Applicant: Samsung Electronics Co., Ltd., Suwon-si (KR)

(72) Inventors: Jinkyo CHUNG, Suwon-si (KR); Dongkyun KANG, Suwon-si (KR); Eunhae PARK, Suwon-si (KR); Eunsun CHAE, Suwon-si (KR)

(21) Appl. No.: 19/271,405

(22) Filed: Jul. 16, 2025

Related U.S. Application Data
(63) Continuation of application No. PCT/KR2024/001479, filed on Jan. 31, 2024.

(30) Foreign Application Priority Data
Feb. 17, 2023 (KR) 10-2023-0021772
Apr. 28, 2023 (KR) 10-2023-0056630

(51) Int. Cl. H04M 1/72412; H04M 1/72409; H04M 1/72436

(52) U.S. Cl. CPC H04M 1/72412; H04M 1/724094; H04M 1/72436

(57) ABSTRACT

An electronic device, comprises: a display, a communication module comprising communication circuitry, a memory, and at least one processor, comprising processing circuitry, operatively connected to the display, the communication module, and the memory, wherein at least one processor, individually and/or collectively, may be configured to cause the electronic device to: identify a connection to an external display device by the communication module; display information related to at least one mode containing at least one function stored in the memory; receive an input for transmitting the information related to the at least one mode to the external display device; and transmit the information related to the at least one mode to the external display on the basis of the input.

### CROSS-REFERENCE TO RELATED APPLICATIONS

This application is a continuation International Application No. PCT/KR2024/001479 designating the United States, filed on Jan. 31, 2024, in the Korean Intellectual Property Receiving Office and claiming priority to Korean Patent Application Nos. 10-2023-0021772, filed on Feb. 17, 2023, and 10-2023-0056630, filed on Apr. 28, 2023, in the Korean Intellectual Property Office, the disclosures of each of which are incorporated by reference herein in their entireties.

### BACKGROUND

### Field

The disclosure relates to an electronic device communicating with a display device, and a method of controlling the same.

### Description of Related Art

Various services and additional functions provided through electronic devices, for example, portable electronic devices such as smartphones, are gradually increasing. In order to increase the utility value of these electronic devices and satisfy the needs of various users, communication service providers or electronic device manufacturers are competitively developing electronic devices that provide various functions and differentiate themselves from other companies. Accordingly, various functions provided through electronic devices are also becoming more advanced.

Various services and additional functions provided through wearable electronic devices such as augmented reality (AR) glasses, virtual reality (VR) glasses, and head-mounted display (HMD) devices are gradually increasing. In order to increase the utility value of these electronic devices and satisfy the needs of various users, communication service providers or electronic device manufacturers are competitively developing electronic devices that provide various functions and differentiate themselves from other companies. Accordingly, various functions provided through wearable electronic devices are also becoming more advanced.

AR glasses or VR glasses may provide users with realistic experiences by displaying virtual images while worn on the user's head. AR glasses or VR glasses may replace the use of smartphones in various fields such as gaming entertainment, education, or social networking services (SNSs). Users may receive content of smartphones and/or content similar to reality through AR glasses or VR glasses worn on their heads.

### SUMMARY

According to an example embodiment, an electronic device may include a display, a communication module, comprising communication circuitry, memory, and at least one processor, comprising processing circuitry, operatively connected to the display, the communication module, and the memory.

According to an example embodiment, at least one processor, individually and/or collectively, may be configured to identify a connection with an external display device through the communication module.

According to an example embodiment, at least one processor, individually and/or collectively, may be configured to cause the electronic device to display, on the display, information related to one or more modes including one or more functions and stored in the memory.

According to an example embodiment, at least one processor, individually and/or collectively, may be configured to cause the electronic device to receive an input for transmitting the information related to the one or more modes to the external display device

According to an example embodiment, at least one processor, individually and/or collectively, may be configured to cause the electronic device to based on the input, transmit the information related to the one or more modes to the external display.

According to an example embodiment, a display device may include a display, a communication module, comprising communication circuitry, and at least one processor, comprising processing circuitry, operatively connected to the display and the communication module.

According to an example embodiment, at least one processor, individually and/or collectively, may be configured to cause the display device to: receive information related to one or more modes respectively including one or more functions from an external electronic device through the communication module.

According to an example embodiment, at least one processor, individually and/or collectively, may be configured to cause the display device to: display a list including the one or more modes on the display.

According to an example embodiment, a method of controlling an electronic device may include identifying a connection with an external display device.

According to an example embodiment, the method of controlling an electronic device may include displaying information related to one or more modes including one or more functions and stored in memory of the electronic device.

According to an example embodiment, the method of controlling an electronic device may include receiving an input for transmitting the information related to the one or more modes to the external display device.

According to an example embodiment, the method of controlling an electronic device may include, based on the input, transmitting the information related to the one or more modes to the external display.

According to an example embodiment, a non-transitory computer-readable recording medium may store one or more programs, and the one or more programs may include instructions that, when executed by at least one processor, comprising processing circuitry, individually and/or collectively, of an electronic device, cause the electronic device to: identify a connection with an external display device through a communication module.

According to an example embodiment, the instructions when executed may cause the electronic device to receive an input for transmitting, to the external display device, the information related to the one or more modes respectively including one or more functions and stored in memory.

According to an example embodiment, the one or more programs may include instructions that, when executed, cause the electronic device to transmit, based on the user input, the information related to the one or more modes to the external display.

According to an example embodiment, a non-transitory computer-readable recording medium may store one or more programs, and the one or more programs may include instructions that, when executed cause the display device to receive information related to one or more modes respectively including one or more functions from an external electronic device through a communication module.

According to an example embodiment, the one or more programs may include instructions that, when executed, cause the display device to display a list including the one or more modes on the display.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a perspective view illustrating an example wearable electronic device according to various embodiments;

FIG. 3A is a front perspective view of an example wearable electronic device according to various embodiments;

FIG. 3B is a rear perspective view of an example wearable electronic device according to various embodiments;

FIG. 4 is a perspective view of an example wearable electronic device according to various embodiments;

FIG. 5 is a flowchart illustrating an example operation of transmitting function-related information classified by mode to an external display device in an electronic device according to various embodiments;

FIG. 6A is a diagram illustrating an example operation of transmitting function-related information classified by mode to an external display device in an electronic device according to various embodiments;

FIG. 6B is a diagram illustrating an example operation of transmitting function-related information classified by mode to an external display device in an electronic device according to various embodiments;

FIG. 6C is a diagram illustrating an example message for identifying whether to display function-related information classified by mode on an external display device in an electronic device according to various embodiments;

FIG. 6D is a diagram illustrating an example operation of transmitting function-related information classified by mode to an external display device in an electronic device according to various embodiments;

FIG. 6E is a diagram illustrating an example operation of transmitting function-related information classified by mode to an external display device in an electronic device according to various embodiments

FIG. 7 is a flowchart illustrating an example operation of classifying functions by mode in an electronic device according to various embodiments;

FIG. 8 is a diagram illustrating a first mode of an electronic device according to various embodiments;

FIG. 9A is a diagram illustrating a second mode of an electronic device according to various embodiments;

FIG. 9B is a diagram illustrating an example operation of an electronic device in a second mode according various embodiments;

FIG. 9C is a diagram illustrating an example operation of an electronic device in a second mode according to various embodiments;

FIG. 10A is a diagram illustrating a third mode of an electronic device according to various embodiments;

FIG. 10B is a diagram illustrating an example operation of an electronic device in a third mode according to various embodiments;

FIG. 11A is a diagram illustrating a fourth mode of an electronic device according to various embodiments;

FIG. 11B is a diagram illustrating an example operation of an electronic device in a fourth mode of according to various embodiments;

FIG. 12 is a diagram illustrating a fifth mode of an electronic device according to various embodiments;

FIG. 13A is a diagram illustrating a plurality of functions included in an application screen according to various embodiments;

FIG. 13B is a diagram illustrating example widget screens for a plurality of functions of an application according to various embodiments;

FIG. 13C is a diagram illustrating widgets for a plurality of functions of an application being displayed in a mode according to various embodiments;

FIG. 14A is a diagram illustrating an example screen of a specific mode including a first function of an application in an electronic device according to various embodiments;

FIG. 14B is a diagram illustrating an example screen of a specific mode including a second function of an application in an electronic device according to various embodiments;

FIG. 14C is a diagram illustrating an example screen of a specific mode including a third function of an application in an electronic device according to various embodiments;

FIG. 15 is a diagram illustrating an example screen of a specific mode in an electronic device and a screen of a specific mode in an external display device according to various embodiments;

FIG. 16 is a diagram illustrating an example layout of widgets included in a screen of a specific mode in an electronic device according to various embodiments;

FIG. 17 is a diagram illustrating an example layout of widgets included in a screen of a specific mode in an electronic device according to various embodiments;

FIG. 18A is a diagram illustrating an example layout of widgets included in a screen of a specific mode in an electronic device according to various embodiments;

FIG. 18B is a diagram illustrating an example layout of widgets included in a screen of a specific mode in an electronic device according to various embodiments;

FIG. 18C is a diagram illustrating an example layout of widgets included in a screen of a specific mode in an electronic device according to various embodiments;

FIG. 19 is a diagram illustrating an example operation of generating a mode of an electronic device according to various embodiments;

FIG. 20A is a diagram illustrating an example mode configured as a function for collecting biometric information according to various embodiments;

FIG. 20B is a diagram illustrating an example mode configured as a function classified as entertainment according to various embodiments;

FIG. 20C is a diagram illustrating an example mode configured as a function used at a specific time zone according to various embodiments;

FIG. 20D is a diagram illustrating an example mode configured as a function used at a specific location according to various embodiments;

FIG. 20E is a diagram illustrating an example mode configured as a function used at a specific time zone according to various embodiments;

FIG. 21 is a diagram illustrating an example operation of generating a mode by user input in an electronic device according to various embodiments;

FIG. 22A is a diagram illustrating a mode list of an external display device according to various embodiments;

FIG. 22B is a diagram illustrating an example operation when one mode is selected from a mode list of an external display device according to various embodiments;

FIG. 22C is a diagram illustrating an example operation when one of the functions in a mode of an external display device is selected according to various embodiments;

FIG. 23 is a diagram illustrating an example operation for displaying an execution screen of at least one function included in a mode of an external display device according to various embodiments; and

FIG. 24 is a diagram illustrating an example type of a mode list of an external display device according to various embodiments.

### DETAILED DESCRIPTION

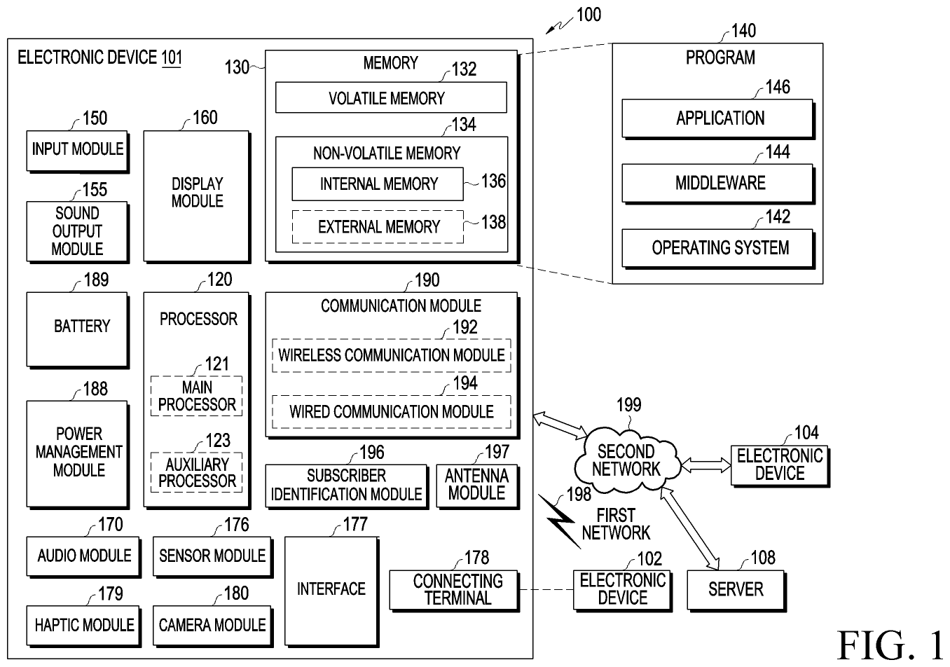

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (cMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating clement including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating clement may be additionally formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

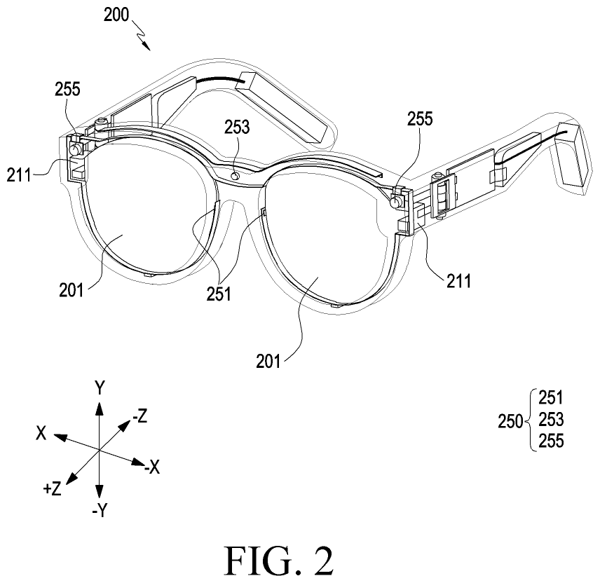

FIG. 2 is a perspective view illustrating a partial internal configuration of an example wearable electronic device according to various embodiments.

Referring to FIG. 2, a wearable electronic device 200 according to an embodiment may include at least one of an optical output module (e.g., including circuitry) 211, a display member (e.g., including a display) 201, and a camera module (e.g., including a camera) 250.

According to an embodiment, the optical output module 211 may include a light source capable of outputting an image, and a lens that guides the image to the display member 201. According to an embodiment, the optical output module 211 may include at least one of a liquid crystal display (LCD), a digital mirror device (DMD), a liquid crystal-on-silicon (LCoS), an organic light-emitting diode (OLED), or a micro light-emitting diode (micro-LED).

According to an embodiment, the display member 201 may include an optical waveguide. According to an embodiment, an output image of the optical output module 211 incident on one end of the optical waveguide may be propagated inside the optical waveguide and provided to a user. According to an embodiment, the optical waveguide may include at least one of a diffractive element (e.g., a diffractive optical element (DOE) or a holographic optical element (HOE)) or a reflective element (e.g., a reflective mirror). For example, the optical waveguide may guide an output image of the optical output module 211 to a user's eye using at least one diffractive element or reflective element.

According to an embodiment, the camera module 250 may capture still images and/or moving images. According to an embodiment, the camera module 250 may be arranged inside a lens frame and may be arranged around the display member 201.

According to an embodiment, a first camera module 251 may include a camera and capture and/or recognize the trajectory of the user's eye (e.g., pupil or iris) or gaze. According to an embodiment, the first camera module 251 may periodically or aperiodically transmit information related to the trajectory of the user's eye or gaze (e.g., trajectory information) to a processor (e.g., the processor 120 in FIG. 1).

According to an embodiment, a second camera module 253 may include a camera and capture an external image.

According to an embodiment, a third camera module 255 may include a camera and be used for hand detection and tracking, and recognition of user's gesture (e.g., hand movements). According to an embodiment, the third camera module 255 may be used for head tracking of 3 DoF (3 degrees of freedom) or 6 DoF, location (space or environment) recognition, and/or movement recognition. The second camera module 253 may be used for hand detection and tracking, and user gesture recognition according to an embodiment. According to an embodiment, at least one of the first camera module 251 to the third camera module 255 may be replaced with a sensor module (e.g., LiDAR sensor). For example, the sensor module may include at least one of a VCSEL (vertical cavity surface emitting laser), an infrared sensor, and/or a photodiode.

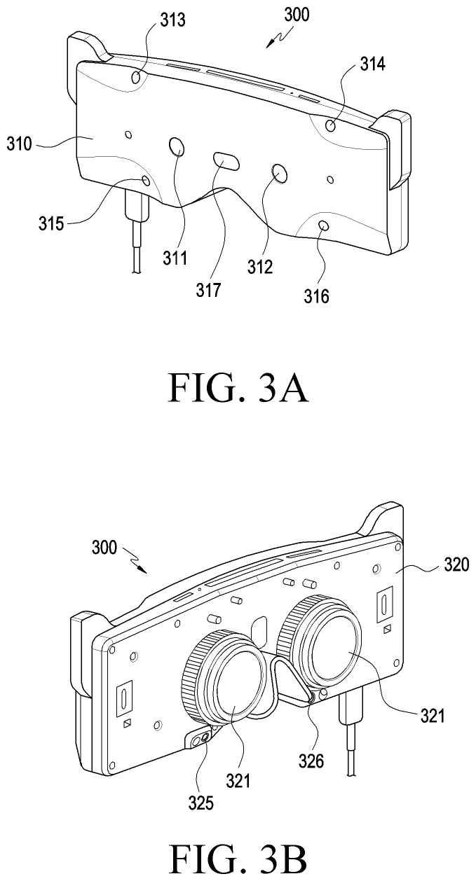

FIG. 3A is a front perspective view of an example wearable electronic device according to various embodiments.

FIG. 3B is a rear perspective view of an example wearable electronic device according to various embodiments.

Referring to FIGS. 3A and 3B, in an embodiment, camera modules 311, 312, 313, 314, 315, and 316 and/or a depth sensor 317 may be arranged on a first surface 310 of a housing to obtain information related to the surrounding environment of a wearable electronic device 300.

In an embodiment, the camera modules 311 and 312 may obtain images related to the surrounding environment of the wearable electronic device.

In an embodiment, the camera modules 313, 314, 315, and 316 may obtain images while the wearable electronic device is being worn on the user. The camera modules 313, 314, 315, and 316 may be used for hand detection, tracking, and recognition of user gestures (e.g., hand movements). The camera modules 313, 314, 315, and 316 may be used for head tracking of 3 DoF or 6 DoF, location (space or environment) recognition, and/or movement recognition. In an embodiment, the camera modules 311 and 312 may also be used for hand detection and tracking, and user gestures.

In an embodiment, the depth sensor 317 may be configured to transmit a signal and receive a signal reflected from a subject, and may be used for the purpose of identifying the distance to an object, such as time of flight (TOF). Instead of or in addition to the depth sensor 217, the camera modules 213, 214, 215, and 216 may identify the distance to an object.

According to an embodiment, a face recognition camera module 325 and 326 and/or a display 321 (and/or a lens) may be arranged on a second surface 320 of the housing.

In an embodiment, the face recognition camera module 325 and 326 adjacent to the display may be used to recognize a user's face, or may recognize and/or track both eyes of the user.

In an embodiment, the display 321 (and/or a lens) may be arranged on the second surface 320 of the wearable electronic device 300. In an embodiment, the wearable electronic device 300 may exclude the camera modules 315 and 316 from the plurality of camera modules 313, 314, 315, and 316. Although not shown in FIGS. 3A and 3B, the wearable electronic device 300 may further include at least one of the configurations shown in FIG. 2.

As described above, the wearable electronic device 300 according to an embodiment may have a form factor to be worn on the user's head. The wearable electronic device 300 may further include a strap and/or a wearing member so as to be fastened to a body part of the user. The wearable electronic device 300 may provide user experiences, based on augmented reality, virtual reality, and/or mixed reality, while being worn on the user's head.

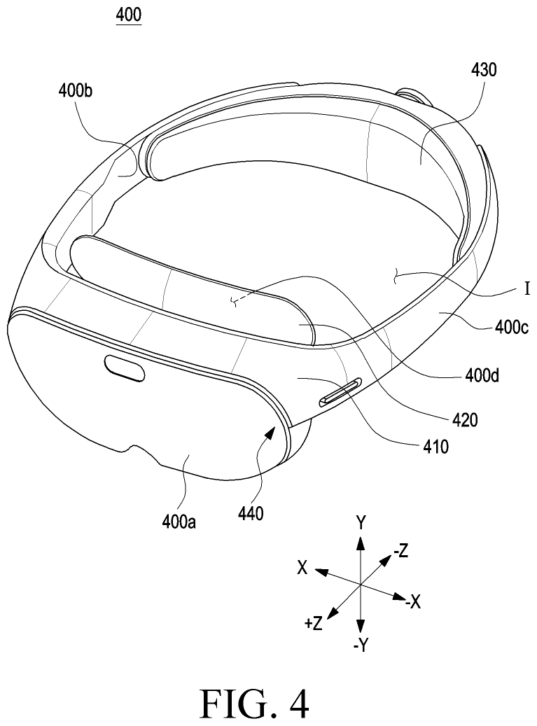

FIG. 4 is a perspective view of an example electronic device according to various embodiments.

Referring to FIG. 4, the electronic device 400 may be a head mounting device (HMD) capable of providing an image in front of the user's eyes. The configuration of the electronic device 400 in FIG. 4 may be all or partly the same as the configuration of the electronic device 200 in FIG. 2.

According to an embodiment, the electronic device 400 may include housings 410, 420, and 430 that may form the exterior of the electronic device 400 and provide a space in which components of the electronic device 400 may be disposed.

According to an embodiment, the electronic device 400 may include a first housing 410 that may surround at least a portion of the user's head. According to an embodiment, the first housing 410 may include a first surface 400a facing the outside (e.g., +Z direction) of the electronic device 400.

According to an embodiment, the first housing 410 may surround at least a portion of the inner space I. For example, the first housing 410 may include a second surface 400b facing the inner space I of the electronic device 400 and a third surface 400c opposite the second surface 400b. According to an embodiment, the first housing 410 may be coupled to a third housing 430 to form a closed curve shape surrounding the inner space I.

According to an embodiment, the first housing 410 may accommodate at least some of the components of the electronic device 400. For example, an optical output module and a circuit board may be disposed inside the first housing 410.

According to an embodiment, the electronic device 400 may include one display member (e.g., including a display) 440 corresponding to the left and right eyes. The display member 440 may be disposed in the first housing 410. The configuration of the display member 440 in FIG. 4 may be all or partly the same as the configuration of the display member 201 in FIG. 2.

According to an embodiment, the electronic device 400 may include a second housing 420 capable of being mounted onto the user's face. According to an embodiment, the second housing 420 may include a fourth surface 400d that may at least partially come into contact with the user's face. According to an embodiment, the fourth surface 400d may be a surface facing the inner space I of the electronic device 400 (e.g., in the −Z direction). According to an embodiment, the second housing 420 may be coupled to the first housing 410.

According to an embodiment, the electronic device 400 may include a third housing 430 capable of being mounted onto the back of the user's head. According to an embodiment, the third housing 430 may be coupled to the first housing 410. According to an embodiment, the third housing 430 may accommodate at least some of the components of the electronic device 400. For example, a battery (e.g., the battery 189 in FIG. 1) may be disposed inside the third housing 430.

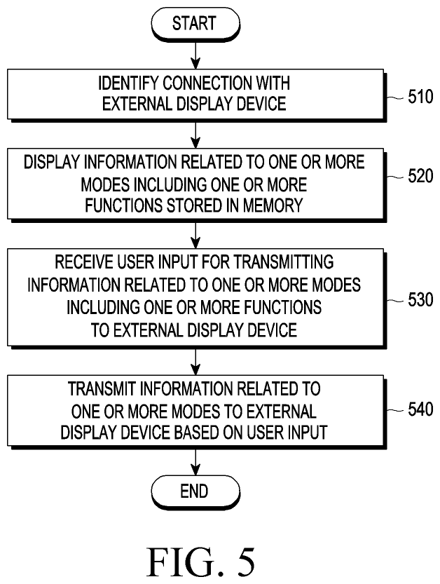

FIG. 5 is a flowchart illustrating an example operation of transmitting function-related information classified by mode to an external display device in an electronic device according to various embodiments.

Referring to FIG. 5, an electronic device (e.g., the electronic device 101 in FIG. 1 or the processor 120 in FIG. 1) may identify that it is connected to an external display device in operation 510.

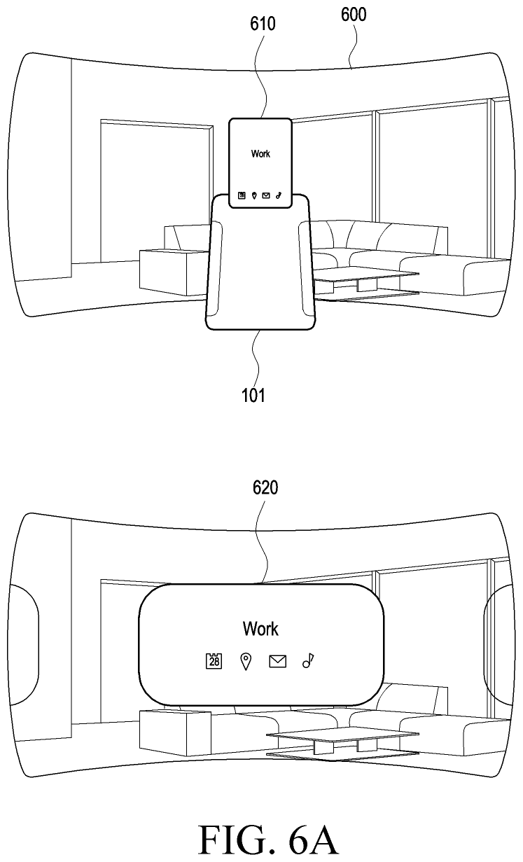

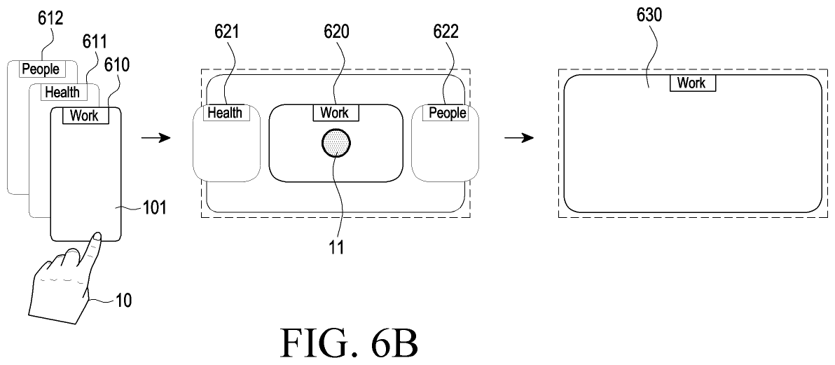

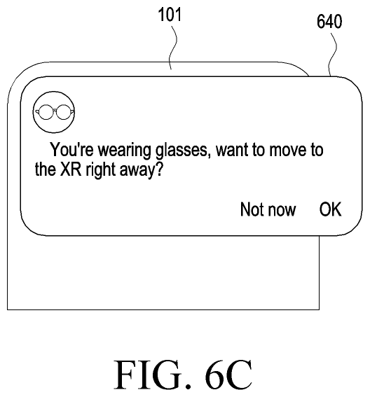

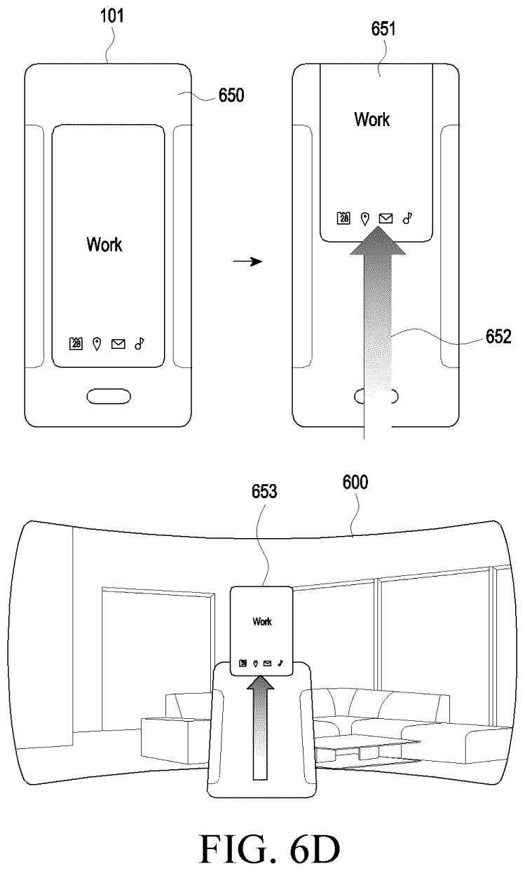

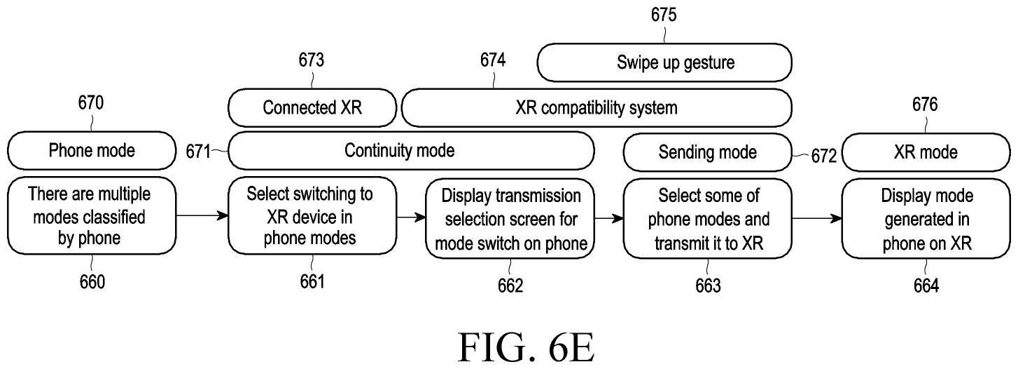

According to an embodiment, the electronic device, based on identifying the electronic device being connected to an external display device (e.g., the electronic device 104 in FIG. 1) through a communication module (e.g., the communication module 190 in FIG. 1), may display a message for identifying whether to display an execution screen of a function of the electronic device on the external display device. According to an embodiment, the message for identifying whether to display an execution screen of a function of the electronic device on the external display device will be described in greater detail below with reference to FIG. 6C.

According to an embodiment, in operation 520, the electronic device may display information related to one or more modes including one or more functions and stored in memory. For example, the information related to one or more modes may include a list including one or more modes.

According to an embodiment, when a message is displayed on an external display device to identify whether to display an execution screen of a function of the electronic device, the electronic device may display a list including one or more modes, based on receiving a user input for displaying an execution screen of a function of the electronic device on the external display device through a message.

According to an embodiment, if an input (e.g., a user input) for displaying an execution screen of a function of the electronic device on the external display device is received through a message while a screen related to one of one or more stored modes is being displayed, the electronic device may display a list including one or more modes. According to an embodiment, the electronic device may display all of the one or more modes in the form of a list, or may display the list in the form of a navigation screen where a mode may be selected by swiping the screen up, down, left, or right.

In an embodiment, the external display device may be a wearable electronic device (e.g., a head-mounted display (HMD) device, augmented reality (AR) glasses, virtual reality (VR) glasses, or extended reality (XR) glasses) in FIGS. 2, 3A, 3B and 4.

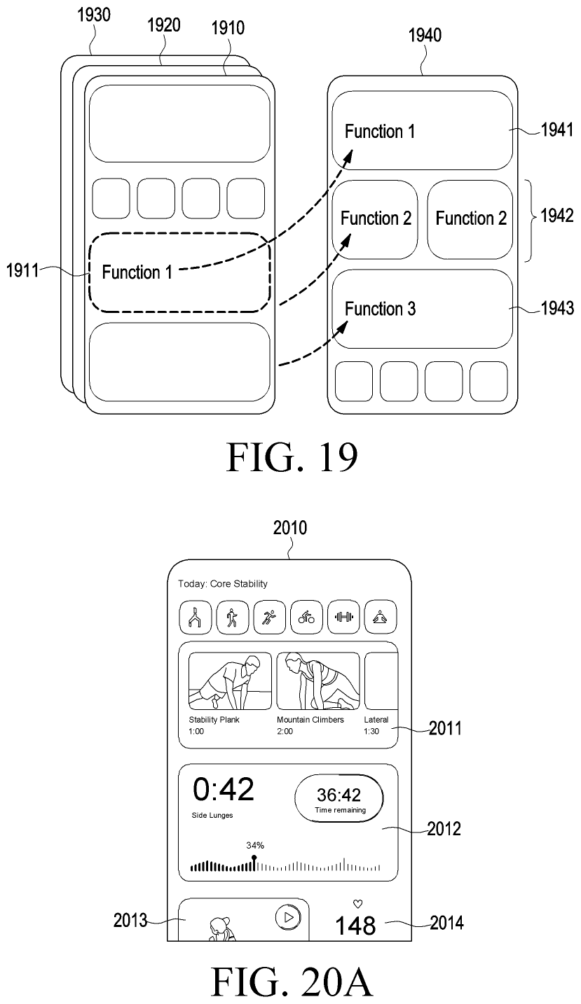

In an embodiment, the electronic device may categorize functions and/or concepts executable on the electronic device into one or more modes. For example, one or more modes may be obtained by categorizing functions and/or concepts executable on the electronic device according to a usage environment. For example, a mode may include a plurality of functions based on relevance of the function, relevance of the content, and/or relevance of the usage environment. According to an embodiment, the mode may include a plurality of functions selected by user input. According to an embodiment, the operation of generating the mode will be described in greater detail below with reference to FIGS. 19, 20A, 20B, 20C, 20D, 20E, and 21.

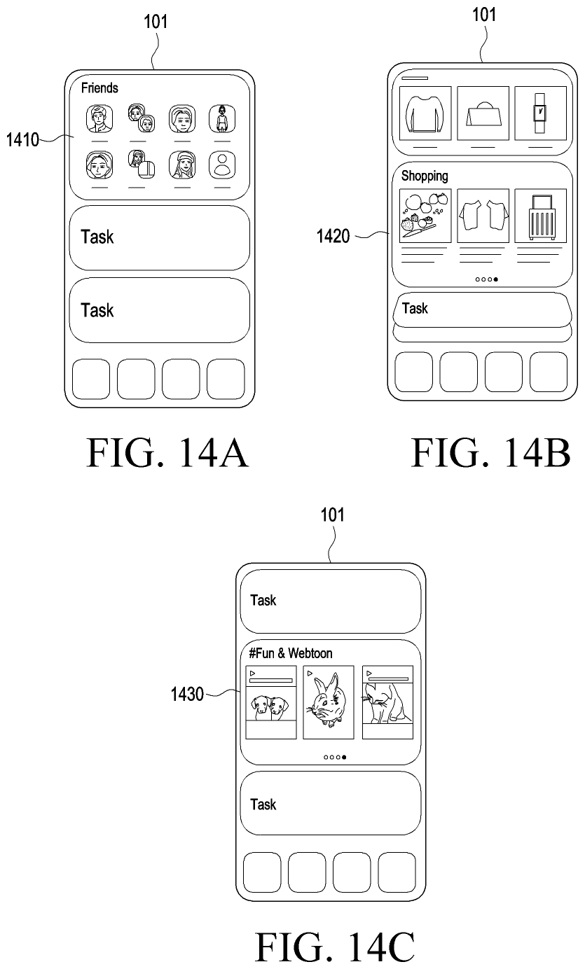

According to an embodiment, different functions of the same application may be included in respective modes, and even if the same function is included, different arrangements, sizes, or amounts of content may be included depending on the content included in the mode and/or layout. According to an embodiment, an embodiment in which different functions are included in the respective modes even for the same application will be described in greater detail below with reference to FIGS. 14A, 14B, and 14C.

For example, one or more modes may include work, people, home, entertainment, and/or health.

According to an embodiment, the screen of each mode may be a page including at least one widget and/or icon.

According to an embodiment, a work mode may be a mode related to the user's work. For example, examples of functions (tasks) that may be included in the work mode may be a calendar application, a schedule application, a reminder application, a map application, a navigation application, an email application, a contact application, and/or a video call application.

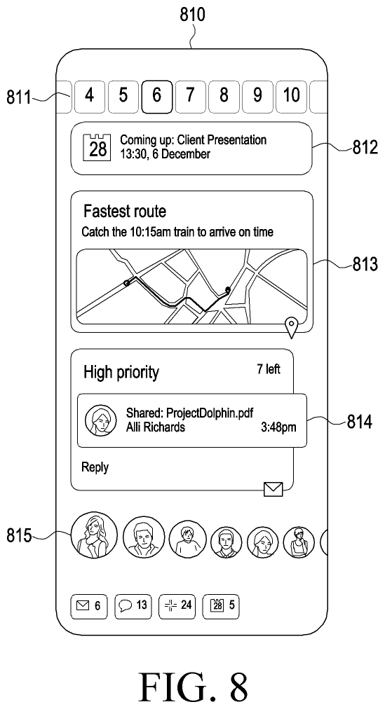

According to an embodiment, an example of a screen of the work mode will be described in greater detail below with reference to FIG. 8.

According to an embodiment, a people mode may be a mode related to communication with people. For example, examples of functions (tasks) that may be included in the people mode may be a SNS application, a message application, a phone application, a contact application, and/or a video call application.

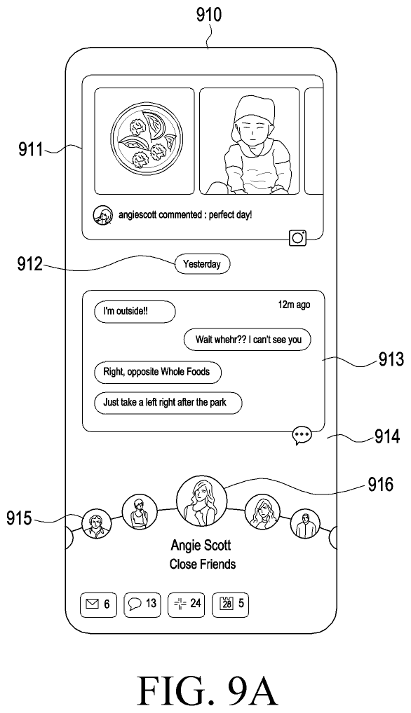

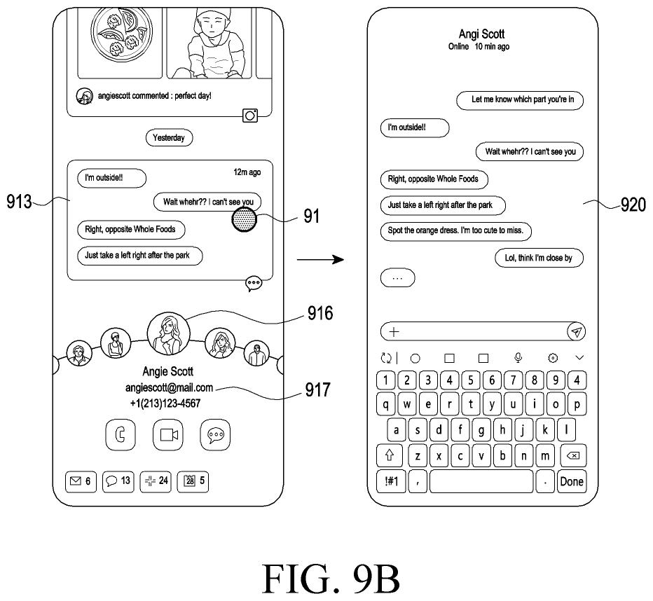

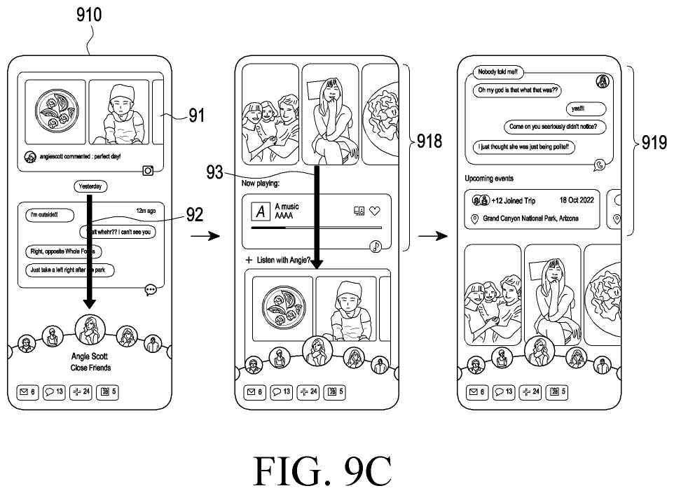

According to an embodiment, examples of a screen of the people mode will be described in greater detail below with reference to FIGS. 9A, 9B and 9C.

According to an embodiment, a home mode may be a mode related to useful information at the time of entering the home screen. For example, examples of functions (tasks) that may be included in the home mode may include a music playback application for identifying currently playing music, a schedule application for identifying today's registered schedule, a message application related to a currently ongoing conversation, and/or a weather application related to the current weather.

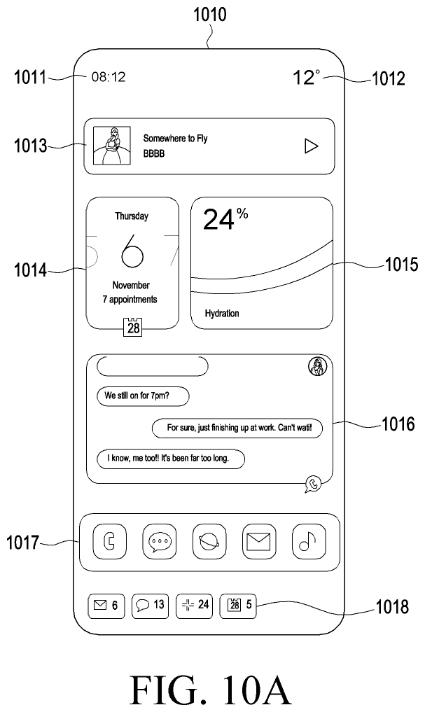

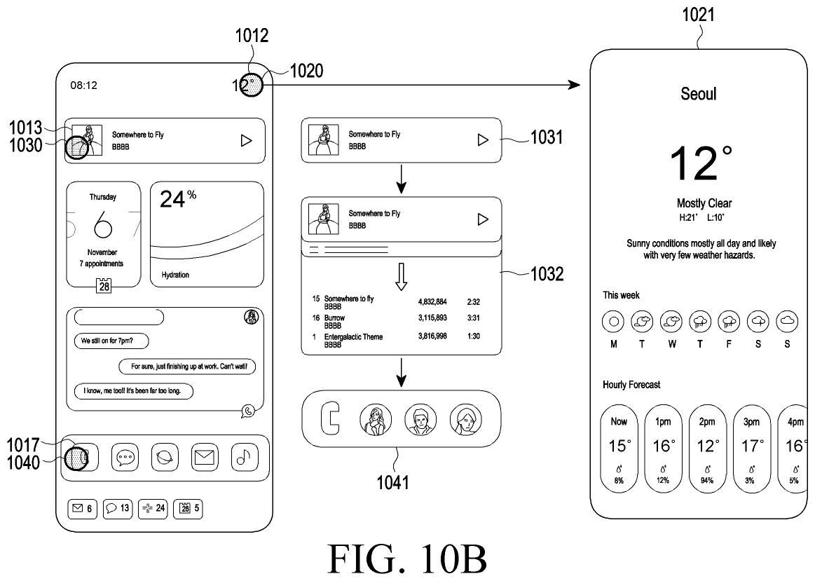

According to an embodiment, examples of a screen of the home mode will be described in greater detail below with reference to FIGS. 10A and 10B.

According to an embodiment, an entertainment mode may be a mode related to the user's leisure. For example, examples of functions (tasks) that may be included in the entertainment mode may include a game broadcasting application, a game shortcut, and/or an OTT application shortcut.

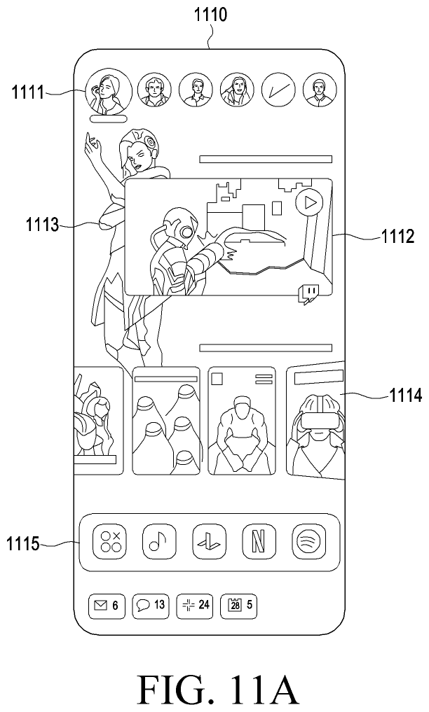

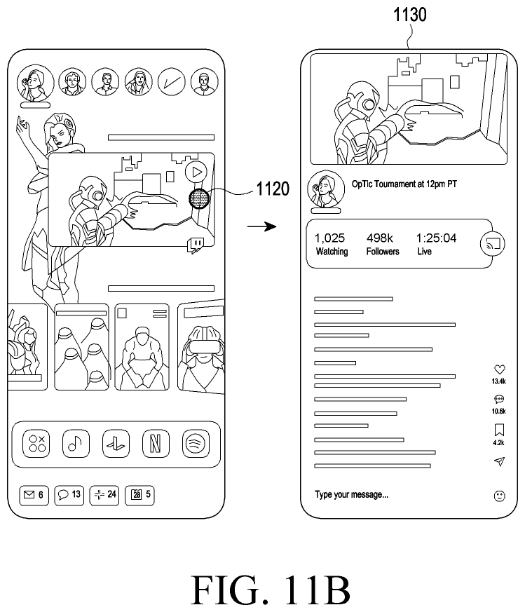

According to an embodiment, examples of a screen of the entertainment mode will be described in greater detail below with reference to FIGS. 11A and 11B.

According to an embodiment, a health mode may be a mode related to the user's health. For example, examples of functions (tasks) that may be included in the health mode may include an exercise video playback application for providing exercise-related training videos, a timer application for exercise progress, and/or a health management application for measuring biometric information such as heart rate and/or current speed.

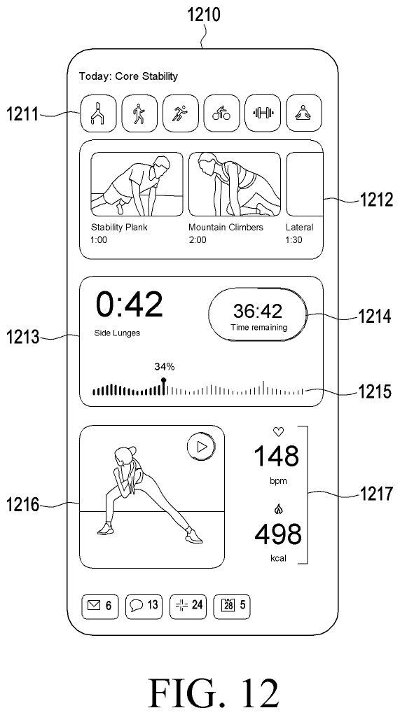

According to an embodiment, an example of a screen of the health mode will be described in greater detail below with reference to FIG. 12.

According to an embodiment, the electronic device may classify one or more functions into one or more modes, based on the types of applications stored in the electronic device, which are related to the functions of the electronic device. For example, when an application is released after development, the function, purpose, and/or utilization scenario of the application may be designated by the developer, and the type of the application may be determined based on the function, purpose, and/or utilization scenario of the application. According to an embodiment, the type of the application may be classified by the market of the application when released.

According to an embodiment, the electronic device may classify one or more functions into one or more modes, based on the usage history of one or more functions. For example, the electronic device may classify one or more functions into one or more modes, based on other functions executed before and after the time at which a specific function is executed and/or usage time. For example, other functions executed before and after a specific function may be classified into the same mode.

According to an embodiment, the electronic device may classify one or more functions into one or more modes if the usage period of the electronic device increases, if classifiable data is accumulated, or if a condition for reclassification is satisfied.

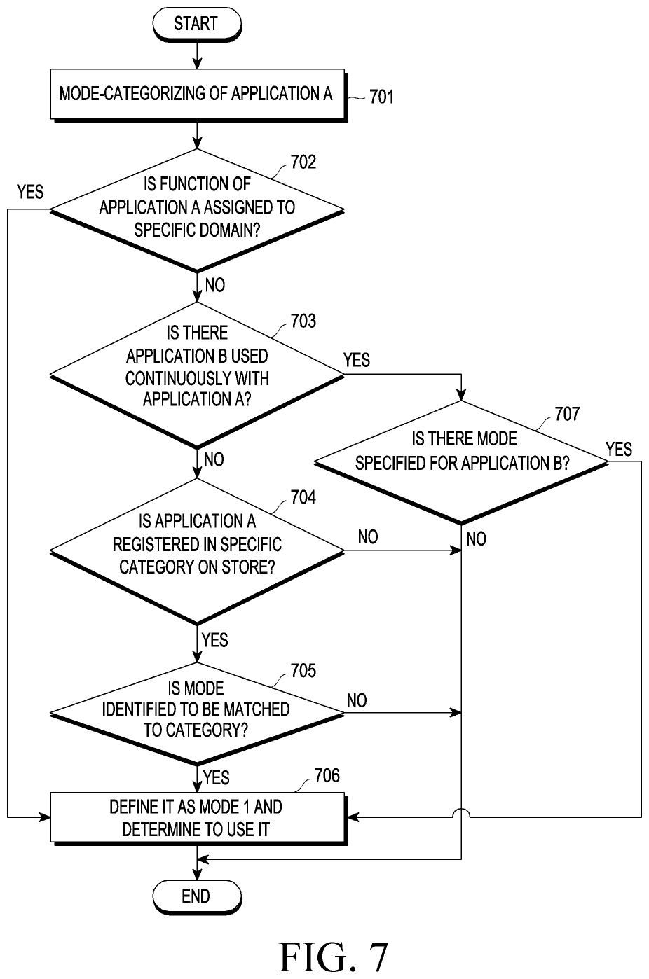

According to an embodiment, an operation of classifying one or more functions of the electronic device will be described in greater detail below with reference to FIG. 7.

According to an embodiment, in operation 530, the electronic device may receive an input (e.g., a user input) for transmitting information related to one or more modes to the external display device.

According to an embodiment, the electronic device may receive a user input for transmitting information related to the mode of the electronic device to an external device while a list including one or more modes is displayed. For example, the user input for transmitting information related to the mode of the electronic device to the external device may be a swipe input from the bottom to the top, or selection of a button for transmitting the information, but it is not limited thereto.

According to an embodiment, in operation 540, the electronic device may transmit information related to the one or more modes to the external display, based on the user input.

According to an embodiment, the information related to the one or more modes may include at least one of identification information of one or more modes, function information included in each of the one or more modes, or content related to the function. For example, the identification information of one or more modes may include the names of respective modes. According to an embodiment, the function information included in each of the one or more modes may be information about one or more functions (tasks) included in each mode. According to an embodiment, the content related to the function may include content to be included in the execution screen of the function.

According to an embodiment, the information related to one or more modes may include arrangement information of the execution screens of the functions included in the one or more modes. According to an embodiment, if the same function is included in different modes, the layout of the execution screen of the function displayed on the external display device may be different between the modes. For example, in the case where a calendar application is included in the work mode and the health mode, respectively, the execution screen of the calendar application may be disposed in a large area at the center of the screen of the external display device in the work mode to identify the schedule, but may be disposed in a small area on one side of the screen of the external display device in the health mode so as not to disrupt exercise.

According to an embodiment, the information related to one or more modes may include at least one of identification information of one or more modes or function information included in each of the one or more modes. According to an embodiment, based on receiving a request for content related to one function among the one or more functions from the external display device, the electronic device may transmit content related to one function to the external display device.

According to an embodiment, if an application related to the function is stored in the external display device, the electronic device may transmit an application execution command related to the function to the external display device.

As described above, it is possible to provide the user with continuous content between the electronic device and the external display device and flexible movement between the XR environment displayed on the external display device and the usage environment of the electronic device.

FIG. 6A is a diagram illustrating an example operation of transmitting function-related information classified by mode to an external display device in an electronic device according to various embodiments.

Referring to FIG. 6A, an external display device (e.g., the electronic device 104 in FIG. 1, the wearable electronic device 200 in FIG. 2, the wearable electronic device 300 in FIG. 3A or FIG. 3B, or the electronic device 400 in FIG. 4) may display a screen 600. The screen 600 may display a surrounding environment or a virtual reality. According to an embodiment, the screen 600 may display a screen of an electronic device 101 (e.g., the electronic device 101 in FIG. 1).

According to an embodiment, if a user input for displaying a screen 610 of the electronic device 101 on the external display device is received, the external display device, based on the user input, may display the screen 610 of the electronic device 101 such that the screen 610 moves from the electronic device 101 to the screen 600.

According to an embodiment, the external display device may receive information related to one or more modes respectively including one or more functions from the electronic device 101 through the communication module.

According to an embodiment, the external display device may display a mode UI 620 corresponding to the screen 610 of the electronic device.

According to an embodiment, the external display device may display a list including one or more modes on the display. For example, the external display device may display a list including one or more modes in a navigation form in which the screen on which the mode UI 620 is displayed is swiped up, down, left, and right, thereby displaying UIs of other modes.

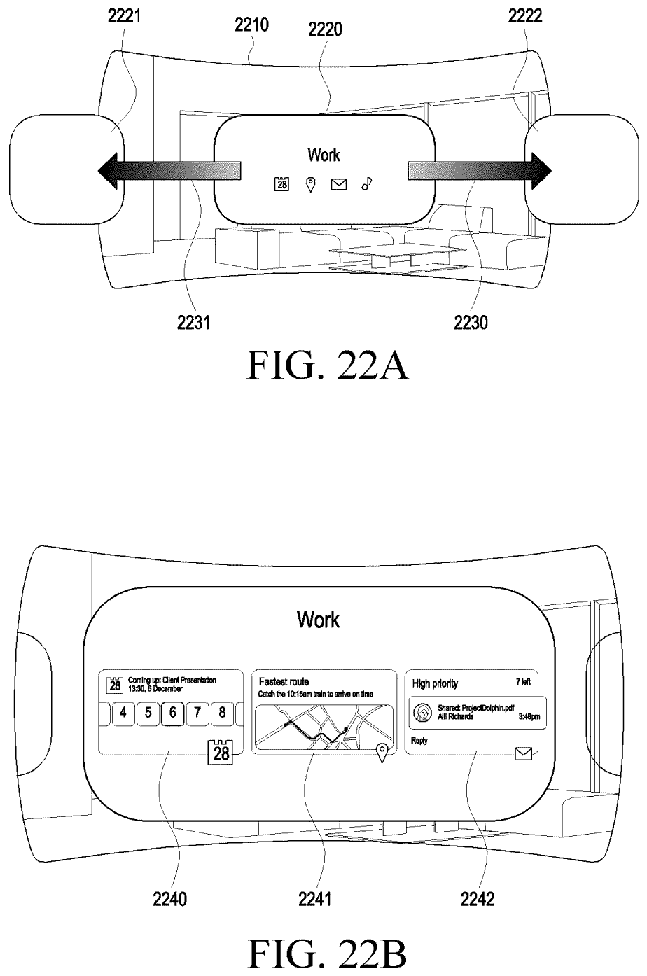

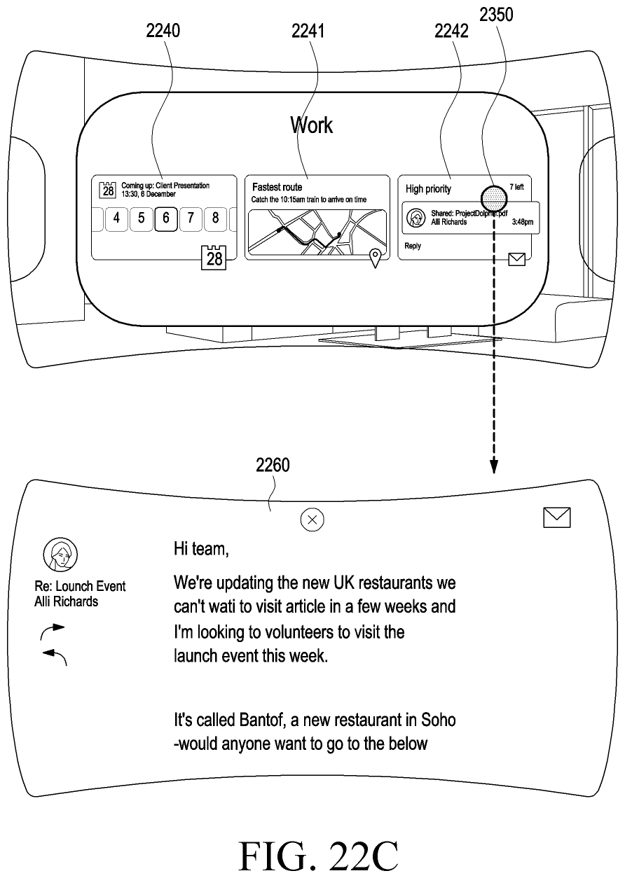

According to an embodiment, an operation of displaying one or more modes received from the electronic device will be described in greater detail below with reference to FIG. 22A.

According to an embodiment, based on receiving a user input for selecting one mode from the list, the external display device may display one or more functions included in one mode.

According to an embodiment, an operation of displaying one or more functions included in one selected mode will be described in greater detail below with reference to FIG. 22B.

According to an embodiment, based on receiving a user input for executing one function among the one or more functions, the external display device may display an execution screen of one function.

According to an embodiment, based on receiving a user input for executing one function among the one or more functions, the external display device may request content related to one function from the electronic device. According to an embodiment, the external display device, based on receiving content related to one function from the electronic device, may display the content related to one function.

According to an embodiment, based on receiving a user input for executing one function among the one or more functions, the external display device may identify whether an application related to one function is stored in the memory of the external display device. According to an embodiment, based on identifying that an application related to one function is stored in the memory, the external display device may display an execution screen of the application related to one function.

According to an embodiment, an operation of displaying the execution screen of a selected function will be described in greater detail below with reference to FIG. 22C.

FIG. 6B is a diagram illustrating an example operation of transmitting function-related information classified by mode to an external display device in an electronic device according to various embodiments.

Referring to FIG. 6B, an electronic device 101 (e.g., the electronic device 101 in FIG. 1 or the processor 120 in FIG. 1) may classify a plurality of functions of the electronic device 101 into a plurality of modes 610, 611, and 612 and store them.

According to an embodiment, the electronic device 101 may identify establishment of a connection with an external display device (e.g., the electronic device 104 in FIG. 1), and then receive a user input 10 (e.g., a swipe input or a button touch input) to display a screen related to the plurality of modes 610, 611, and 612 of the electronic device 101 on the external display device. According to an embodiment, each of the screens related to the plurality of modes 610, 611, and 612 may be in the form of a home screen.

According to an embodiment, the electronic device 101, after identifying that it is connected to an external display, may display a message for identifying whether to display an execution screen of a function of the electronic device 101 on the external display device, as illustrated in FIG. 6C, before the user input 10 for displaying the screens related to the plurality of modes 610, 611, and 612 of the electronic device 101 on the external display device.

FIG. 6C is a diagram illustrating an example message for identifying whether to display function-related information classified by mode on an external display device in an electronic device according to various embodiments.

Referring to FIG. 6C, the electronic device 101 may display a message 640 for identifying whether to display an execution screen of a function of the electronic device 101 on the external display device, based on identifying the connection with the external display device through a communication module (e.g., the communication module 190 in FIG. 1).

According to an embodiment, the electronic device 101 may display a screen including a list including one or more modes 610, 611, and 612, as illustrated in FIG. 6D, based on receiving a user input for displaying an execution screen of a function of the electronic device 101 on the external display device through the message 640.

FIG. 6D is a diagram illustrating an example operation of transmitting function-related information classified by mode to an external display device in an electronic device according to various embodiments.

Referring to FIG. 6D, the electronic device 101, based on receiving the user input for displaying an execution screen of a function of the electronic device 101 on the external display device through the message 640, may display a screen 650 including a list including one or more modes.

According to an embodiment, if a user input 652 for transmitting one mode 651 of the one or more modes to the external display device is received, the electronic device 101 may transmit information related to the one or more modes to the external display device.

According to an embodiment, the electronic device 101 may move a screen for the one mode 651 upward as if the one mode 651 were moved to the external display device.

According to an embodiment, the external display device may display the screen of the mode 653 such that the screen of the mode 651 displayed on the electronic device 101 moves away from the electronic device 101 and such that the screen of the mode 653 corresponding to the mode 651 displayed on the electronic device 101 moves to the screen 600 of the XR environment.

As described above, a continuous mode display environment between the electronic device 101 and the external display device may be provided to the user.

Referring back to FIG. 6B, the external display device may display a list including one or more modes 620, 621, and 622 on the screen 600 of the XR environment. For example, the screens respectively corresponding to one or more modes 620, 621, and 622 may be aligned horizontally, and the mode may be changed by swiping the screen left and right. According to an embodiment, the alignment of the screens corresponding to one or more modes 620, 621, and 622 is not limited thereto, and may be aligned vertically or to overlap each other.

According to an embodiment, if a user input for displaying an execution screen of a function of the electronic device on the external display device is received through a message 640, the electronic device 101 may switch to a state capable of transmitting information related to the mode, so that the categorized mode may be easily transmitted to the XR environment of the external display through a user gesture.

According to an embodiment, when a user input 11 for selecting one mode 620 from among the one or more modes 620, 621, and 622 is received, the external display device may display a screen 630 related to the selected mode 620. For example, the screen 630 related to the selected mode 620 may include information related to one or more functions included in the selected mode 620.

According to an embodiment, when the electronic device 101 is in the state capable of transmitting information related to a mode, the external display may be in any state.

FIG. 6E is a diagram illustrating an example operation of transmitting function-related information classified by mode to an external display device in an electronic device according to various embodiments.

Referring to FIG. 6E, in operation 660, the electronic device (e.g., a phone) may have a plurality of classified modes. According to an embodiment, the electronic device may be in a phone mode 670 that is not linked to an external display device (e.g., an XR device).

According to an embodiment, in operation 661, the electronic device may select to switch from the phone mode to the XR device after establishing a connection 673 with the external display device. According to an embodiment, in operation 662, a transmission selection screen for switching modes may be displayed on the electronic device. For example, the transmission selection screen may be the screen 650 in FIG. 6D.

According to an embodiment, in operation 661 and operation 662, the electronic device may be in a continuity mode 671. According to an embodiment, the continuity mode 671 may be a state where a connection with an external display device is recognized and where a standby screen is provided for connecting to an XR environment.

According to an embodiment, from operation 662, the electronic device and the external display device may be in an XR compatibility system 674 in which they communicate with each other.

According to an embodiment, if a gesture input (e.g., swipe-up gesture) 675 for screen transmission is input, the electronic device may switch to a sending mode 672, and select some of the phone modes and transmit them to the external display device in operation 663.

For example, the electronic device may mirror at least a portion of the screen of the selected mode displayed on the electronic device and transmit the same to the external display device.

According to an embodiment, the electronic device may transmit information about settings and states for the applications and/or content respectively corresponding to the widgets, icons, and/or execution screens included in the selected mode to the external display device.

According to an embodiment, the external display device may display the widgets, icons, and/or execution screens, based on the information about settings and states received from the electronic device. According to an embodiment, the information about settings and states received from the electronic device may include data and/or files being processed by the application corresponding to the function included in the selected mode.

According to an embodiment, the external display device may receive and display the widgets, icons, and/or execution screens from a server, based on the information about settings and states received from the electronic device. According to an embodiment, the widgets, icons, and/or execution screens received from the server may include data and/or files being processed by the application corresponding to the function included in the selected mode.

According to an embodiment, if an application and/or content included in the mode selected is stored in an external display, the external display device may display widgets, icons, and/or execution screens stored in the external display device, based on the information about settings and states received from the electronic device.

According to an embodiment, the widgets, icons, and/or execution screens displayed on the external display device may be the same as the widgets, icons, and/or execution screens displayed on the electronic device, or the amount and/or layout of the content included may vary depending on the size of the display.

According to an embodiment, the mode may switch to an XR mode 676 in which the XR environment is used, and the external display device may display the mode generated in the phone in operation 664. According to an embodiment, the external display device may display the mode generated in the electronic device by adjusting the size and position of the UI to conform to the specifications of the display of the external display device.

FIG. 7 is a flowchart illustrating an example operation of classifying functions by mode in an electronic device according to various embodiments.

Referring to FIG. 7, an electronic device (e.g., the electronic device 101 in FIG. 1 or the processor 120 in FIG. 1) may perform mode categorization on application A in operation 701.

According to an embodiment, in operation 702, the electronic device may identify whether a function of application A is assigned to a specific domain. According to an embodiment, the electronic device may identify whether a function of application A is assigned to a specific domain when disclosed by a developer.

According to an embodiment, if it is identified that the function of application A is assigned to a specific domain (Yes in operation 702), the electronic device may define application A as mode 1 in operation 706.

According to an embodiment, if it is identified that the function of application A is not assigned to a specific domain (No in operation 702), the electronic device may identify whether there is application B that is used continuously with application A in operation 703. According to an embodiment, the electronic device may identify whether there is application B that is used continuously with application A, based on the usage history of the electronic device.

According to an embodiment, if it is identified that there is no application B that is used continuously with application A (No in operation 703), the electronic device may identify whether application A is registered in a specific category on the store in operation 704. According to an embodiment, the electronic device may identify whether application A is registered in a specific category by an administrator of the store when application A is released.

According to an embodiment, if application A is registered in a specific category on the store (Yes in operation 704), the electronic device may identify a mode capable of being matched to the category in operation 705.

According to an embodiment, if there is a mode capable of being matched to the category (Yes in operation 705), it may be defined as mode 1 in operation 706.

According to an embodiment, if there is no mode capable of being matched to the category (No in operation 705), the electronic device may terminate the categorizing operation of application A. According to an embodiment, if the electronic device satisfies configured conditions, it may re-perform the categorizing of application A in operation 701. For example, the configured conditions may include a configured cycle and/or use of application A. As described above, as data related to the use patterns of application A is accumulated and as the usage period increases, application A may be reclassified.

According to an embodiment, if application A is not registered in a specific category on the store (No in operation 704), the electronic device may terminate the categorizing operation of application A. According to an embodiment, if the configured conditions are satisfied, the electronic device may re-perform the categorizing of application A in operation 701. For example, the configured conditions may include a configured cycle and/or the use of application A. As described above, as data related to the use patterns of application A is accumulated and as the usage period increases, application A may be reclassified.

According to an embodiment, if it is identified that there is application B continuously used with application A (Yes in operation 703), the electronic device may identify whether there is a mode specified for application B in operation 707.

According to an embodiment, if there is a mode (e.g., mode 1) specified for application B (Yes in operation 707), the electronic device may define application A as mode 1 in operation 706.

According to an embodiment, if there is no mode specified for application B (No in operation 707), the electronic device may terminate the categorizing operation of application A. According to an embodiment, if configured conditions are satisfied, the electronic device may re-perform the categorizing of application A in operation 701. For example, the configured conditions may include a configured cycle and/or the use of Application A. As described above, as data related to the use patterns of application A is accumulated and as the usage period increases, application A may be reclassified.

In FIG. 7, although determinations as to whether the domain of the function of the application is specified, whether there is an application that is used continuously, or whether the category is registered are sequentially determined, the disclosure is not limited thereto, and the sequence may be vary, or determination may be performed in parallel.

FIG. 8 is a diagram illustrating an example first mode of an electronic device according to various embodiments. For example, FIG. 8 is an example of a screen of a work mode.

Referring to FIG. 8, an electronic device (e.g., the electronic device 101 in FIG. 1 or the processor 120 in FIG. 1) may display a screen 810 of a work mode.

For example, the screen 810 of the work mode may include a function 811 of changing a date in relation to a calendar application. According to an embodiment, the function 811 capable of changing a date may change a date by swiping starting from the current date, and the content displayed on the screen 810 of the work mode may also be changed according to the changed date.

According to an embodiment, the screen 810 of the work mode may include a function 812 of displaying highlighted calendar events. For example, highlighted events among the schedules at the changed date may be displayed.

According to an embodiment, the screen 810 of the work mode may include a navigation function 813 of guiding a route from a starting point to a scheduled work location. For example, a route to the scheduled work location may be displayed, based on a schedule at the changed date, with the current location (or input location) as a starting point.

According to an embodiment, the screen 810 of the work mode may display a high priority mail or data 814 in relation to a messenger and/or mail application.

According to an embodiment, the screen 810 of the work mode may include a function 815 in relation to a contact application, which displays recently contacted information, frequently contacted information, and/or favorited contacts.

FIG. 9A is a diagram illustrating an example second mode of an electronic device according to various embodiments. For example, FIG. 9A is an example of a screen of a people mode.

Referring to FIG. 9A, an electronic device (e.g., the electronic device 101 in FIG. 1 or the processor 120 in FIG. 1) may display a screen 910 of a people mode.

For example, the screen 910 of the people mode may include a widget 911 of an SNS application. According to an embodiment, the widget 911 of the SNS application may display recently updated posts. According to an embodiment, the SNS application widget 911 may display recently updated posts of a channel designated or subscribed to by a user.

According to an embodiment, the screen 910 of the people mode may include an indicator 912 indicating a timeline. For example, the indicator 912 indicating a timeline may display an update time of a recently updated post and/or a schedule of communication with people.

According to an embodiment, the screen 910 of the people mode may include a widget 913 showing a recently performed conversation in relation to a messenger application. According to an embodiment, the screen 910 of the people mode may include an icon 914 of a messenger application related to the widget 913 indicating a recently performed conversation.

According to an embodiment, the screen 910 of the people mode may include a widget 915 that displays high-priority contacts in relation to a contact application. For example, the high-priority contacts may include recently used contacts, frequently used contacts, and/or favorited contacts.

According to an embodiment, the widget 915 indicating high-priority contacts may include a feature 916 capable of distinguishing between contacts. For example, the feature 916 for distinguishing between contacts may include photos, images, text, and/or emojis.

FIG. 9B is a diagram illustrating an example operation of an electronic device in a second mode according to various embodiments.

Referring to FIG. 9B, if the electronic device receives a user input 91 for selecting a widget 913 showing a recently performed conversation, the electronic device may display an execution screen 920 of a messenger application in which the conversation was performed. For example, a recently performed conversation window may be displayed.

According to an embodiment, if a feature 916 of one of the high-priority contacts is selected, the electronic device may further display information 917 stored in the selected contact. For example, the information 917 stored in the selected contact may further include a phone number and/or an email.

FIG. 9C is a diagram illustrating an example operation of an electronic device in a second mode according to various embodiments.

Referring to FIG. 9C, if a user input 92 is received to perform dragging downward on a screen 910 of a people mode in which a widget 911 of an SNS application is displayed at the top, the electronic device may move the widget 911 of the SNS application to the bottom of the screen and display another function 918 disposed above the widget 911 of the SNS application. For example, another function 918 disposed above the widget 911 of the SNS application may include a function related to music currently being played and/or a widget related to another SNS application.

According to an embodiment, if a user input 93 is received to perform dragging downward while a function related to a currently playing music, which is another function 918 disposed above the widget 911 of the SNS application, and/or a widget related to another SNS application is disposed at the top of the screen, the electronic device may move the widget related to another SNS application to the bottom of the screen and display another function 919 disposed above the widget related to another SNS application. For example, another function 919 disposed above the widget related to another SNS application may be a widget that displays a shared schedule and/or conversations conducted in another messenger application.

FIG. 10A is a diagram illustrating an example third mode of an electronic device according to various embodiments. For example, FIG. 10A illustrates an example of a screen of a home mode.

Referring to FIG. 10A, an electronic device (e.g., the electronic device 101 in FIG. 1 or the processor 120 in FIG. 1) may display a screen 1010 of a home mode.

According to an embodiment, the screen 1010 of the home mode may include a widget 1011 that displays the current time in relation to a clock application.

According to an embodiment, the screen 1010 of the home mode may include a widget 1012 that displays the temperature of the current location of the electronic device in relation to a weather application.

According to an embodiment, the screen 1010 of the home mode may include a widget 1013 of a music playback application that includes information on music that is currently being played or has recently been played in relation to a music playback application.

According to an embodiment, the screen 1010 of the home mode may include a widget 1014 that displays a schedule in relation to a calendar application. For example, the widget 1014 displaying a schedule may display the next schedule or a schedule specified by the user.

According to an embodiment, the screen 1010 of the home mode may include a widget 1015 that displays the chance of rain in the current location of the electronic device in relation to the weather application.

According to an embodiment, the screen 1010 of the home mode may include a widget 1016 that displays a high-priority chat window in relation to the messenger application.

According to an embodiment, the screen 1010 of the home mode may include a group of icons 1017 of applications most frequently used by the user and/or applications configured by the user.

According to an embodiment, the screen 1010 of the home mode may include a notification 1018 that notifies of an event that has occurred in the electronic device. For example, the notification 1018 that notifies of an event that has occurred in the electronic device may include an icon of an application in which a new notification has occurred and/or information on the number of new notifications.

FIG. 10B is a diagram illustrating an example operation of an electronic device in a third mode according to various embodiments.

Referring to FIG. 10B, if a user input 1020 for selecting a widget 1012 that displays the temperature in the current location of the electronic device is received, the electronic device may display an execution screen 1021 of the weather application. For example, the execution screen 1021 of the weather application may further include location information, temperatures by time zone, or weather information.

According to an embodiment, if a user input 1030 for selecting a widget 1013 of a music playback application is received, the electronic device may display an execution screen 1031 of a music playback application. According to an embodiment, the execution screen 1031 of the music playback application may further include a music playlist 1032.

According to an embodiment, upon receiving a user input 1040 for selecting an icon (e.g., an icon of a call application) from among a group of icons 1017 including applications most frequently used by the user and/or configured by the user, the electronic device may display information 1041 having a high priority in relation to the application corresponding to the selected icon. For example, if the selected icon is an icon of a call application, the electronic device may display recent contacts, frequently contacted contacts, and/or favorited contacts.

FIG. 11A is a diagram illustrating an example fourth mode of an electronic device according to various embodiments. For example, FIG. 11A is an example of a screen of an entertainment mode.

Referring to FIG. 11A, an electronic device (e.g., the electronic device 101 in FIG. 1 or the processor 120 in FIG. 1) may display a screen 1110 of an entertainment mode.

For example, the screen 1110 of the entertainment mode may include a list 1111 of influencers followed by many other users and/or users followed by the user of the electronic device in relation to an SNS application or a game application.

According to an embodiment, the screen 1110 of the entertainment mode may display a widget 1112 on which a video is displayed in relation to a game application or a video playback application. The widget 1112 on which a video is displayed may be a live video or thumbnail image of a game.

According to an embodiment, the screen 1110 of the entertainment mode may include a 3D avatar 1113 of a character included in the widget 1112 on which the video is displayed.

According to an embodiment, the screen 1110 of the entertainment mode may include a recommended video list 1114 in relation to the video playback application. For example, the recommended video list 1114 may include videos related to previously played videos and/or videos preferred by the user.

According to an embodiment, the screen 1110 of the entertainment mode may include a list of recently used applications 1115 among a plurality of applications included in the entertainment mode.

FIG. 11B is a diagram illustrating an example operation of an electronic device in a fourth mode of according to various embodiments.

Referring to FIG. 11B, if a user input 1120 for selecting a widget on which the video is displayed is received, an execution screen 1130 of the video may be displayed. For example, the execution screen 1130 of the video is an execution screen of a video playback application, and may include publisher information related to the video, information related to the video, information related to concurrent users, or a chat window.

FIG. 12 is a diagram illustrating an example fifth mode of an electronic device according to various embodiments. For example, FIG. 12 shows an example of a screen of a health mode.

Referring to FIG. 12, an electronic device (e.g., the electronic device 101 in FIG. 1 or the processor 120 in FIG. 1) may display a screen 1210 of a health mode.

For example, the screen 1210 of the health mode may include a function 1211 that guides the types of exercises to be performed today.

According to an embodiment, the screen 1210 of the health mode may include a list of images 1212 related to the exercises to be performed.

According to an embodiment, the screen 1210 of the health mode may include a timer function 1213 related to exercise. For example, the timer function 1213 related to exercise may display the remaining time for the next exercise.

According to an embodiment, the screen 1210 of the health mode may include a timer function 1214 that displays the remaining exercise time. For example, the timer function 1214 of displaying the remaining exercise time may display the remaining time of the total exercise to be performed today.

According to an embodiment, the screen 1210 of the health mode may include a function 1215 that displays the progress of the exercise. For example, the function 1215 that displays the progress of the exercise may display the amount of the exercise performed and the remaining amount of the total exercise to be performed today.

According to an embodiment, the screen 1210 of the health mode may include an image 1216 related to the exercise currently being performed.

According to an embodiment, the screen 1210 of the health mode may include biometric information 1217 of the current user. For example, the biometric information 1217 of the current user may include heart rate and/or calories burned. According to an embodiment, the user's biometric information 1217 may be biometric information measured by the electronic device and/or measured by a wearable electronic device (e.g., a smart watch) linked to the electronic device.

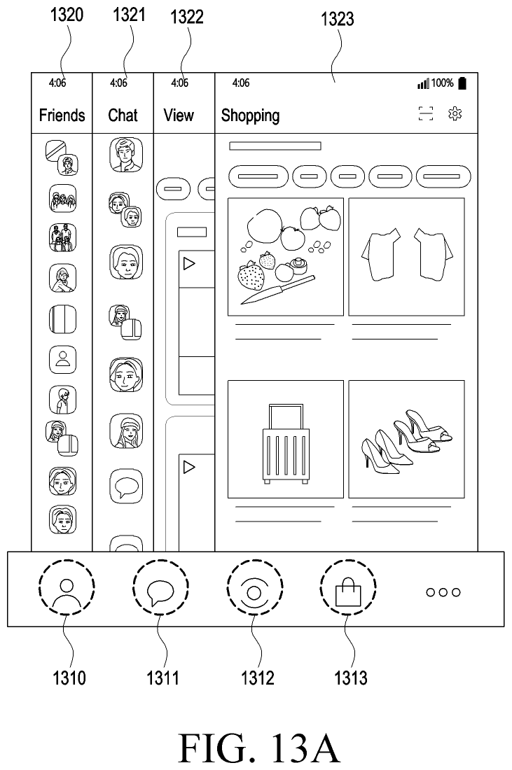

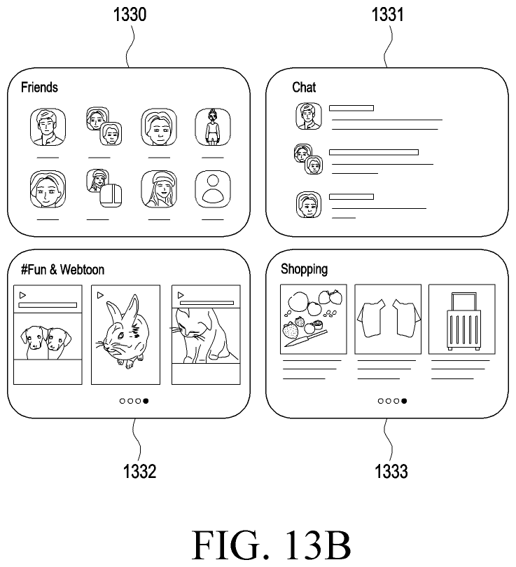

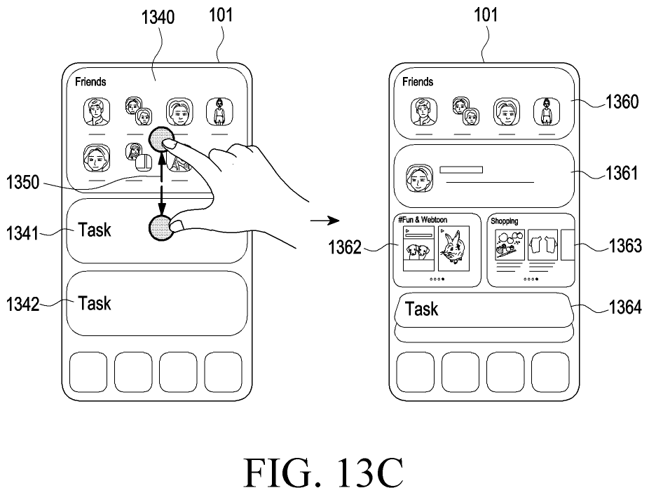

FIG. 13A is a diagram illustrating a plurality of functions included in an application screen according to various embodiments.

Referring to FIG. 13A, an application of an electronic device (e.g., the electronic device 101 in FIG. 1 or the processor 120 in FIG. 1) may include a plurality of themes (or functions or tasks). According to an embodiment, the screen of the application may include a plurality of themes and tabs 1310, 1311, 1312, and 1313 respectively corresponding to the themes. According to an embodiment, if one of the tabs 1310, 1311, 1312, and 1313 is selected, the screen of the application may display a screen corresponding to the selected tab from among a plurality of screens 1320, 1321, 1322, and 1323 respectively corresponding to the plurality of tabs 1310, 1311, 1312, 1313.

For example, a chat application may include a screen 1320 related to a contact list, a screen 1321 related to a chat window list, a screen 1322 related to news and information, and a screen 1323 related to shopping. According to an embodiment, the respective screens 1320, 1321, 1322, and 1323 may include various forms of layouts.

According to an embodiment, the electronic device may generate widgets illustrated in FIG. 13B, based on content and/or layouts included in the theme-specific screens 1320, 1321, 1322, and 1323 of the application, and the generated widgets may be included in the screen of each mode.

FIG. 13B is a diagram illustrating example widget screens for a plurality of functions of an application according to various embodiments.

Referring to FIG. 13B, the electronic device may generate a task module included in the screen of the mode, based on content and/or layout included in the screen of the application. For example, the task module may be a widget or may include characteristics of a widget including content and/or functions included in the screen of the application. In the disclosure, the task module will be described as a “widget” for convenience of explanation, but is not limited thereto. For example, the electronic device may generate a widget corresponding to the screen of the application, based on content and/or layout provided by the provider of the application, as illustrated in FIG. 16, or may generate a widget corresponding to the screen of the application, based on some content and/or layout of the screen of the application.

According to an embodiment, the electronic device may generate a widget 1330 related to the contact list, based on the screen 1320 related to the contact list illustrated in FIG. 13A. For example, the widget 1330 related to the contact list may include information (e.g., profiles, contact names, or contact numbers) of contacts that have been recently contacted, frequently contacted, or added to favorites, based on the content and/or layout included in the screen 1320 related to the contact list.

According to an embodiment, the electronic device may generate a widget 1331 related to the chat window list, based on the screen 1321 related to the chat window list illustrated in FIG. 13A. For example, the widget 1331 related to the chat window list may include information (e.g., a counterpart's profile or recent conversation history) of a chat window in which chatting has been recently or frequently performed, or added to favorites, based on the content and/or layout included in the screen 1321 related to the chat window list.

According to an embodiment, the electronic device may generate a widget 1332 related to news or information, based on the screen 1322 related to news and information illustrated in FIG. 13A. For example, the widget 1332 related to news or information may include thumbnails or headlines of major news and/or major information, based on the content and/or layout included in the screen 1322 related to news and information.

According to an embodiment, the electronic device may generate a widget 1333 related to shopping, based on the screen 1323 related to shopping illustrated in FIG. 13A. For example, the widget 1333 related to shopping may include shopping information, based on the content and/or layout included in the screen 1323 related to shopping.

As described above, even for the same application, different widgets may be included depending on the mode.

FIG. 13C is a diagram illustrating example widgets for a plurality of functions of an application are displayed in a mode according to various embodiments.

Referring to FIG. 13C, the electronic device 101 may display a screen of a mode including a plurality of widgets 1340, 1341, and 1342 corresponding to a plurality of tasks, respectively.

According to an embodiment, if a user input for enlarging one of the plurality of widgets 1340, 1341, and 1342 is received, the electronic device 101 may display a plurality of widgets for the application of the widget on which the user input was received.

For example, among the plurality of widgets 1340, 1341, and 1342, a first widget 1340 may be related to a contact list of a chat application. According to an embodiment, upon receiving a user input 1350 for enlarging the first widget 1340, the electronic device 101 may display a plurality of widgets 1360, 1361, 1362, and 1363 related to the chat application. For example, the 1-1^{st} widget 1360 related to the chat application may be obtained by reducing the size of the first widget 1340 related to the contact list. According to an embodiment, the 1-2^{nd} widget 1361 related to the chat application may be a widget related to a chat window list. According to an embodiment, the 1-3^{rd} widget 1362 related to the chat application may be a widget related to news and information. According to an embodiment, the 1-4^{th} widget 1363 related to the chat application may be a widget related to shopping.

According to an embodiment, as the area where the widget related to the chat application is displayed is expanded, the electronic device 101 may display a fourth widget 1364 in which the previously displayed second widget 1341 and third widget 1342 overlap.

FIG. 14A is a diagram illustrating an example screen of a specific mode including a first function of an application in an electronic device according to various embodiments. For example, FIG. 14A illustrates a screen of a first mode (e.g., communication mode).

FIG. 14B is a diagram illustrating an example screen of a specific mode including a second function of an application in an electronic device according to various embodiments. For example, FIG. 14B illustrates a screen of a second mode (e.g., commerce mode).

FIG. 14C is a diagram illustrating an example screen of a specific mode including a third function of an application in an electronic device according to various embodiments. For example, FIG. 14C illustrates a screen of a third mode (e.g., entertainment mode).

Referring to FIG. 14A, an electronic device 101 (e.g., the electronic device 101 in FIG. 1 or the processor 120 in FIG. 1) may include a widget 1410 related to a first function of an application on a screen of a first mode (e.g., communication mode). For example, the electronic device 101 may display a widget 1410 related to a contact list of a chat application.

Referring to FIG. 14B, the electronic device 101 may include a widget 1420 related to a second function of the application on a screen of a second mode (e.g., commerce mode). For example, the electronic device 101 may display a widget 1420 related to shopping of the chat application.

Referring to FIG. 14C, the electronic device 101 may include a widget 1430 related to a third function of the application on a screen of the third mode (e.g., entertainment mode). For example, the electronic device 101 may display a widget 1430 related to news or information of the chat application.

As described above, according to an embodiment, in the case where one application provides a plurality of themes (or functions or tasks), one or more widgets may be generated depending on the properties of the content included in the respective themes. In addition, the generated widgets may be included in screens of different modes depending on their properties.

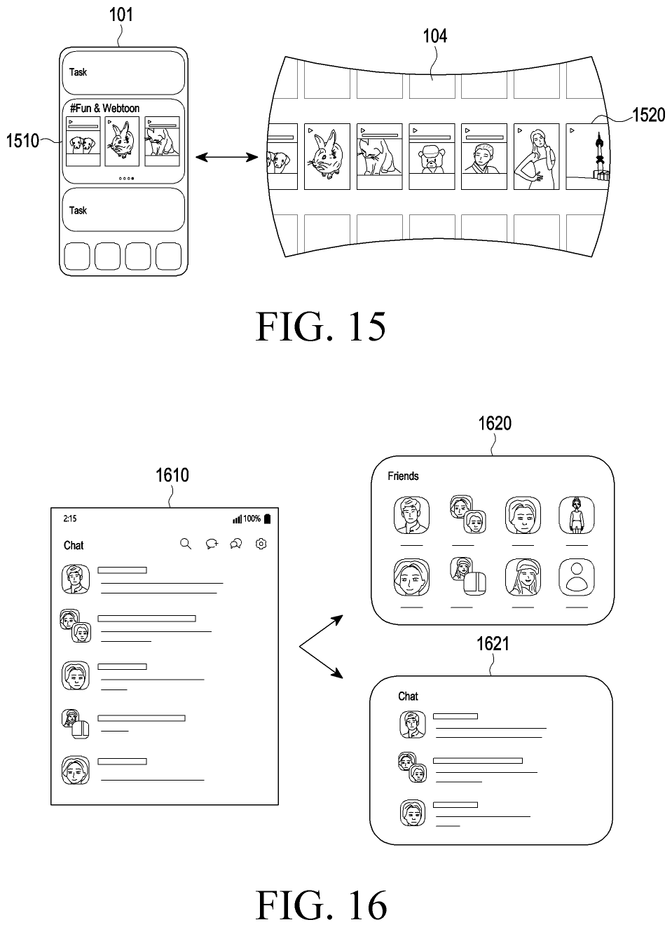

FIG. 15 is a diagram illustrating an example screen of a specific mode in an electronic device and a screen of a specific mode in an external display device according to various embodiments.

Referring to FIG. 15, an electronic device 101 (e.g., the electronic device 101 in FIG. 1 or the processor 120 in FIG. 1) may display a widget 1510 related to a function of an application on a screen of a mode. According to an embodiment, the widget 1510 may include a 2D object (e.g., an icon and/or a thumbnail).

According to an embodiment, the amount and/or layout of content displayed on the widget 1510 may be determined according to the size of the screen of the electronic device 101. For example, the widget 1510 related to one function of the application may include a small amount of content in the electronic device 101 as a smart phone, whereas the widget 1520 related to one function of the application may include more content when an external display device 104 (e.g., the electronic device 104 in FIG. 1), as an XR device, displays a screen of the mod. According to an embodiment, the widget 1510 related to one function of the application may include an icon and/or a thumbnail in the electronic device 101 as a smart phone, whereas the widget 1520 related to one function of the application may include an execution screen in the external display device 104 as an XR device.

According to an embodiment, when the electronic device 101 and the external display device 104 are connected based on an account and/or a short-range communication technology, the electronic device 101 and the external display device 104 may transmit information of one or more modes to each other, thereby displaying the mode screen. According to an embodiment, the amount and/or layout of content may vary depending on the characteristics of the display of the device on which the screen of the mode is to be displayed.

FIG. 16 is a diagram illustrating an example layout of widgets included in a screen of a specific mode in an electronic device according to various embodiments.

Referring to FIG. 16, an electronic device (e.g., the electronic device 101 in FIG. 1 or the processor 120 in FIG. 1) may generate a widget (or task), based on content and/or layout included in a screen 1610 of an application. For example, the electronic device may generate a widget 1620 corresponding to the screen of the application, based on content and/or layout provided by the provider of the application, or generate a widget 1621 corresponding to the screen of the application, based on some content and/or layout of the screen of the application.

For example, a widget 1620 generated for a screen 1610 related to a chat window list, based on content and/or layout provided by the provider of the application, may include profile information of the counterpart of the favorite chat window. According to an embodiment, the widget 1620 generated based on content and/or layout provided by the provider of the application may be an interface that is not provided on the screen 1610 of the application.

According to an embodiment, a widget 1621 generated for the screen 1610 related to a chat window list, based on some of content and/or layout of the screen of the application may include a portion of the screen 1610 related to the chat window list.

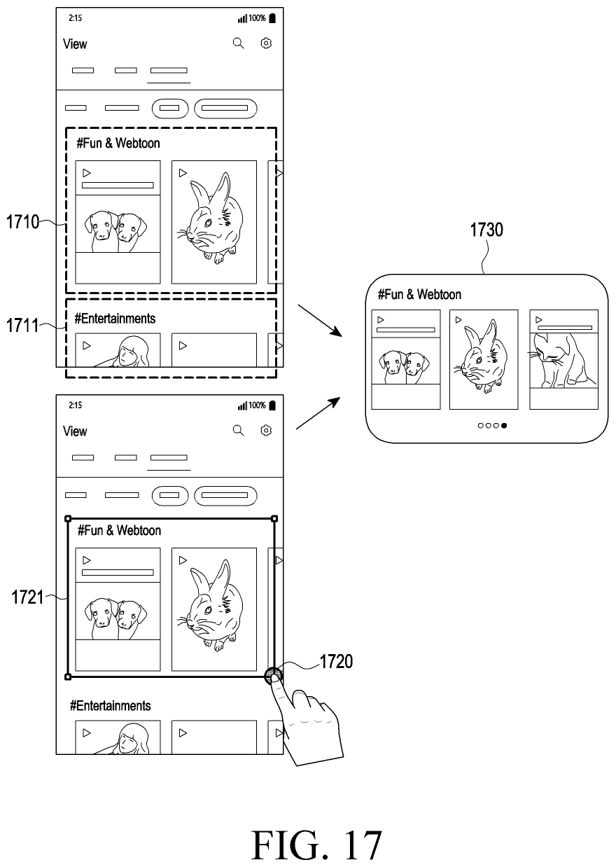

FIG. 17 is a diagram illustrating an example layout of widgets included in a screen of a specific mode in an electronic device according to various embodiments.

Referring to FIG. 17, an electronic device (e.g., the electronic device 101 in FIG. 1 or the processor 120 in FIG. 1) may recognize a layout of a screen of an application and recommend regions 1710 and 1711 capable of being used as a widget. According to an embodiment, the electronic device may display the regions 1710 and 1711 capable of being used as a widget from the screen of the application.

According to an embodiment, the electronic device may generate a widget 1730, based on a region selected from among the regions 1710 and 1711 capable of being used as a widget.

According to an embodiment, the electronic device may generate a widget 1730 for a region 1721 selected based on a user input 1720. For example, the user input 1720 may be a drag input for selecting the region.

According to an embodiment, the electronic device may crop the region selected by the user input 1720 and mirror the cropped region to generate the widget 1730.

According to an embodiment, if a user input for selecting an object included in the widget 1730 is received, the electronic device may display a screen of an application corresponding to the selected object.

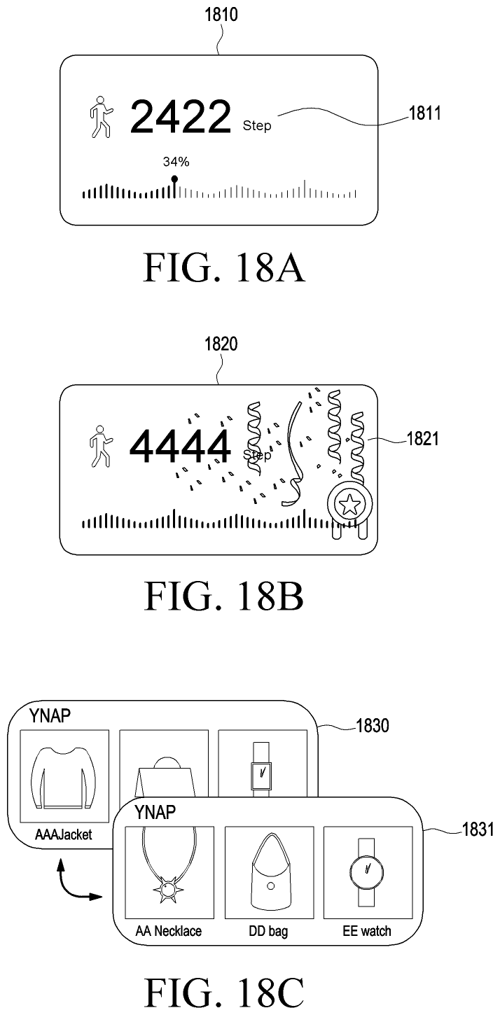

FIG. 18A is a diagram illustrating an example layout of widgets included in a screen of a specific mode in an electronic device according to various embodiments.

Referring to FIG. 18A, an electronic device (e.g., the electronic device 101 in FIG. 1 or the processor 120 in FIG. 1) may generate a widget 1810 including information 1811 for performing a function. For example, the information may be generated by an operating system or the use of an application. For example, the information may include text, sound, images, and/or videos.

For example, the electronic device may generate a widget 1810 including the number of steps 1811 acquired through a gyro sensor of the electronic device using a pedometer function of a health application.

FIG. 18B is a diagram illustrating an example layout of widgets included in a screen of a specific mode in an electronic device according to various embodiments.

Referring to FIG. 18B, the electronic device may generate a widget 1820 including information 1821 generated when the operating system or the use conditions of the application satisfy configured conditions. For example, the information may include text, sound, images, and/or videos.

For example, the electronic device may generate a widget 1820 including a visualized event 1821 for a reward when the measured number of steps exceeds a specific value. According to an embodiment, information related to the visualized event 1821 may be generated when the use conditions satisfy the configured conditions.

FIG. 18C is a diagram illustrating an example layout of widgets included in a screen of a specific mode in an electronic device according to various embodiments.

Referring to FIG. 18C, the electronic device may generate widgets 1830 and 1831, based on information transmitted from an operating system or the provider of an application.

For example, if a widget related to a shopping application is included in the screen of the mode, the electronic device may generate and display a first widget 1830 including product information (e.g., an image or a product name) provided from the provider of the shopping application.

According to an embodiment, if information about another product is provided from the provider of the shopping application according to a configured time and/or trend after the electronic device displays the first widget 1830, the electronic device may generate and display a second widget 1831 including information about another product.

FIG. 19 is a diagram illustrating an example operation of generating a mode of an electronic device according to various embodiments.

Referring to FIG. 19, an electronic device (e.g., the electronic device 101 in FIG. 1 or the processor 120 in FIG. 1) may generate a mode including functions of a plurality of applications, based on the relevance of functions, the relevance of content, and/or the relevance of a use situation.

For example, the electronic device may generate a screen of a first mode 1940, based on a first function 1911 included in a screen 1910 of a first application, a function included in a screen 1920 of a second application, and/or a function included in a screen 1930 of a third application.

For example, the electronic device may generate a screen 1940 of a first mode including a first widget 1941 generated based on a first function 1911 included in a screen 1910 of a first application, a second widget 1942 generated based on a function included in a screen 1920 of a second application, and/or a third widget 1943 generated based on a function included in a screen 1930 of a third application.

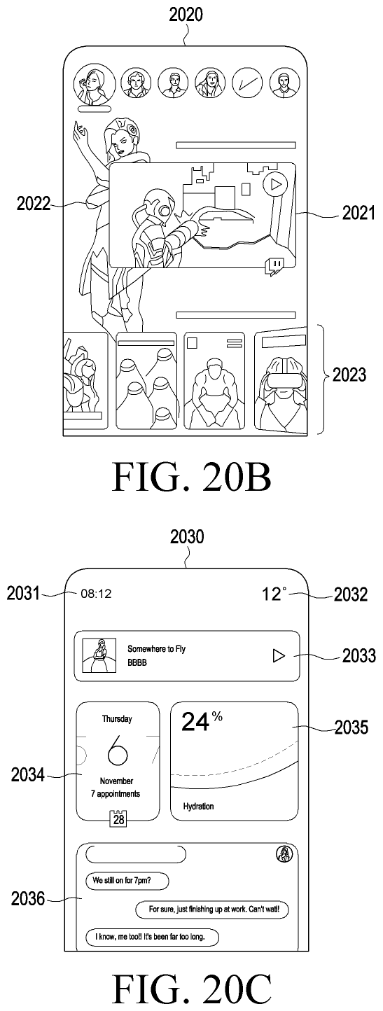

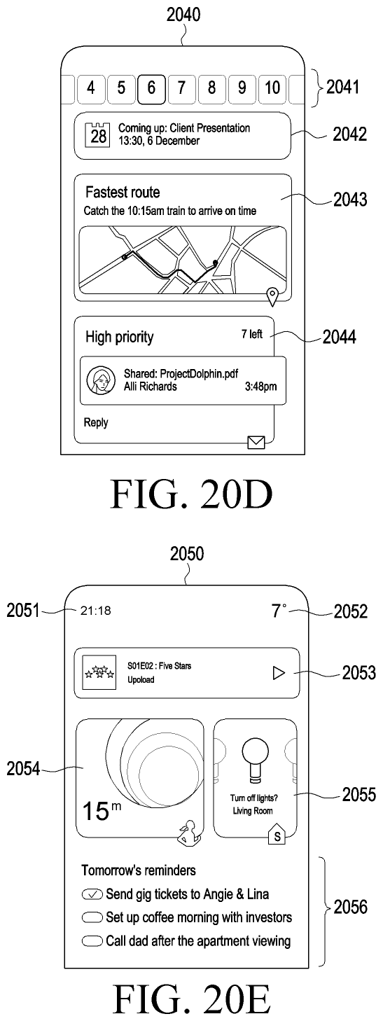

According to an embodiment, when generating a mode based on the relevance of functions, the electronic device may generate a mode including a function of a phone application, a function of a message application, a function of a contact application, and/or a function of a messenger application. According to an embodiment, the mode generated based on the relevance of functions will be described in more detail with reference to FIG. 20A below.

According to an embodiment, when generating a mode based on the relevance of content, the electronic device may generate a mode including a function of a health application, a function of a game application, and/or a function of an entertainment application. According to an embodiment, the mode generated based on the relevance of content will be described in greater detail below with reference to FIG. 20B.

According to an embodiment, when generating a mode based on the relevance of a use situation, the electronic device may generate a mode including a function of a weather application, a function of a navigation application, a function of a messenger application, and/or a function of a memo application. According to an embodiment, the mode generated based on the relevance of a use situation will be described in greater detail below with reference to FIGS. 20C, 20D, and 20E.

FIG. 20A is a diagram illustrating an example mode including a function for collecting biometric information according to various embodiments.

Referring to FIG. 20A, an electronic device (e.g., the electronic device 101 in FIG. 1 or the processor 120 in FIG. 1) may generate a mode including functions for collecting biometric information. According to an embodiment, a screen 2010 of a mode including functions for collecting biometric information may include a widget 2011 including a list of images related to exercise.

According to an embodiment, the screen 2010 of the mode including functions for collecting biometric information may include a widget 2012 including information related to the progress of an exercise. For example, the information related to the progress of an exercise may include information about the remaining time for the next exercise, the remaining time of the total exercise to be performed, and/or the amount of the exercise performed and the remaining amount of the total exercise to be performed.

According to an embodiment, the screen 2010 of the mode including functions for collecting biometric information may include a video 2013 related to the exercise currently being performed.

According to an embodiment, the screen 2010 of the mode including functions for collecting biometric information may include biometric information 2014 of the current user. For example, the biometric information 2014 of the user may include heart rate and/or calories burned. According to an embodiment, the biometric information 2014 of the user may include biometric information measured by the electronic device and/or measured by a wearable electronic device (e.g., a smart watch) linked to the electronic device.

FIG. 20B is a diagram illustrating an example mode including a function classified as entertainment according to various embodiments.

Referring to FIG. 20B, the electronic device may generate a mode including functions classified according to the type of content. For example, the electronic device may generate a mode including functions classified as entertainment. According to an embodiment, a screen 2020 of a mode including functions classified as entertainment may include a widget 2021 on which a video is displayed in relation to a game application or a video playback application. For example, the widget 2021 on which a video is displayed may be a live video or thumbnail image of a game.

According to an embodiment, the screen 2020 of the mode including functions classified as entertainment may include a 3D avatar 2022 of a character included in the widget 2021 on which a video is displayed.

According to an embodiment, the screen 2020 of the mode including functions classified as entertainment may include a list of recommended videos 2023 in relation to a video playback application. For example, the recommended video list 2023 may include videos related to previously played videos and/or videos preferred by the user.

FIG. 20C is a diagram illustrating an example mode including a function used at a specific time zone according to various embodiments.

Referring to FIG. 20C, the electronic device may generate a mode including functions classified according to a use situation. For example, the electronic device may generate a mode including functions used in the morning.

According to an embodiment, a screen 2030 of a mode including functions used in the morning may include a widget 2031 displaying the current time and/or a widget 2032 displaying the temperature of the current location of the electronic device.

According to an embodiment, the screen 2030 of the mode including functions used in the morning may include a widget 2033 of a music playback application including information about music currently being played or recently played.

According to an embodiment, the screen 2030 of the mode including functions used in the morning may include a widget 2034 displaying a schedule. For example, the widget 2034 displaying a schedule may display the next schedule or a schedule specified by the user.

According to an embodiment, the screen 2030 of the mode including functions used in the morning may include a widget 2035 displaying the chance of rain at the current location of the electronic device.

According to an embodiment, the screen 2030 of the mode including functions used in the morning may include a widget 2036 displaying a high-priority chat window.

As described above, the electronic device may provide weather, news, navigation, or music playback applications used in the morning as one mode even if they have no similarity between categories or functions but have patterns of being used at similar times and places. This allows the user to execute a necessary function in one mode without entering each application.

FIG. 20D is a diagram illustrating an example mode including a function used at a specific location according to various embodiments.

Referring to FIG. 20D, the electronic device may generate a mode including functions classified according to a use situation. For example, the electronic device may generate a mode including functions used in a company.

According to an embodiment, a screen 2040 of a mode including functions used in a company may include a widget 2041 capable of changing a date. According to an embodiment, the widget 2041 capable of changing a date may change a date by swiping starting from the current date, and the content displayed on the screen 2040 may also change according to the changed date.

According to an embodiment, the screen 2040 of the mode including functions used in a company may include a widget 2042 that displays a highlighted calendar event. For example, a highlighted event among the schedules at the changed date may be displayed.

According to an embodiment, the screen 2040 of the mode including functions used in a company may include a navigation widget 2043 that guides a route from a starting point to a scheduled work location. For example, a route to the scheduled work location may be displayed, based on a schedule at the changed date, with the current location (or input location) as a starting point.

According to an embodiment, the screen 2040 of the mode including functions used in a company may include a widget 2044 that displays high-priority mail or data in relation to a messenger and/or mail application.

As described above, the electronic device may provide calendar, navigation, or messenger applications used in a company as one mode even if they have no similarity between categories or functions but have patterns of being used at similar times and places. This allows a user to execute a necessary function in one mode without entering each application.

FIG. 20E is a diagram illustrating an example mode including a function used at a specific time zone according to various embodiments.

Referring to FIG. 20E, the electronic device may generate a mode including functions classified according to a use situation. For example, the electronic device may generate a mode including functions used in the evening.

According to an embodiment, a screen 2050 of a mode including functions used in the evening may include a widget 2051 displaying a current time and/or a widget 2052 displaying the temperature of a current location of the electronic device.

According to an embodiment, the screen 2050 of the mode including functions used in the evening may include a widget 2053 of a music playback application including information about music currently being played or recently played.

According to an embodiment, the screen 2050 of the mode including functions used in the evening may include a widget 2054 displaying the wind speed at a current location of the electronic device.

According to an embodiment, the screen 2050 of the mode including functions used in the evening may include a widget 2055 for controlling a connected device. For example, the widget 2055 for controlling a connected device may include a widget capable of turning on/off lights included in a living room and/or a room.

According to an embodiment, the screen 2050 of the mode including functions used in the evening may include a widget 2056 for displaying a major schedule. For example, the widget 2056 for displaying a major schedule may display the next schedule or a schedule specified by a user.

As described above, the electronic device may provide weather, peripheral device control, or music playback applications used in the evening as one mode even if they have no similarity between categories or functions but have patterns of being used at similar times and places. This allows a user to execute a necessary function in one mode without entering each application.

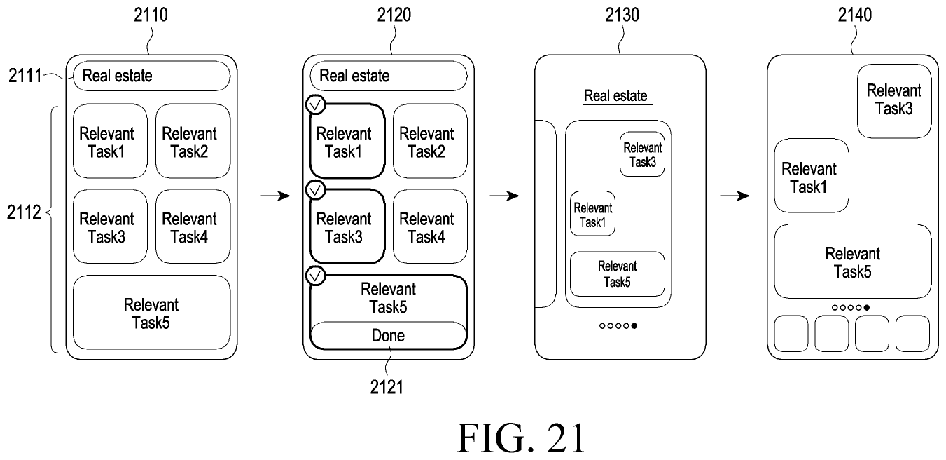

FIG. 21 is a diagram illustrating an example operation of generating a mode by user input in an electronic device according to various embodiments.

Referring to FIG. 21, an electronic device (e.g., the electronic device 101 in FIG. 1 or the processor 120 in FIG. 1) may generate a mode based on a user input. For example, a user may generate a mode by gathering related functions according to the application preference, the frequency of use, and/or a specific purpose.

According to an embodiment, if a user input for searching for a keyword 2111 is received through a mode generation screen 2110, the electronic device may display a function list 2112 related to the keyword 2111.

According to an embodiment, if a user input for selecting at least one of a plurality of functions included in the function list 2112 is received, the electronic device may display a screen 2120 displaying the selected function from among the plurality of functions included in the function list 2112.

According to an embodiment, if the electronic device completes function selection, the electronic device may generate a mode, based on the selected function. For example, upon receiving a user input for selecting a button 2121 to complete function selection, the electronic device may display an editing screen 2130 for generating a mode, based on the selected function.

According to an embodiment, the electronic device may receive a user input for the name of a mode and/or the arrangement of widgets corresponding to the selected function through the editing screen 2130 for generating the mode.

According to an embodiment, if the mode generation is completed, the electronic device may display a screen 2140 of the generated mode.

As described above, the electronic device may provide a mode generated by the user's manual input, instead of a mode generated by the use of the electronic device, thereby providing an experience for the user to use desired functions without entering a separate application at the time of need.

FIG. 22A is a diagram illustrating an example mode list of an external display device according to various embodiments.

Referring to FIG. 22A, an external display device (e.g., the electronic device 104 in FIG. 1, the wearable electronic device 200 in FIG. 2, the wearable electronic device 300 in FIG. 3A or FIG. 3B, or the electronic device 400 in FIG. 4) may receive information related to one or more modes respectively including one or more functions from an electronic device (e.g., the electronic device 101 in FIG. 1) through a communication module.

According to an embodiment, the external display device may display a screen 2210 including a list including one or more modes 2220, 2221, and 2222 on a display. For example, an icon of an application related to the one or more functions included in the mode 2220 may be displayed in the mode 2220 displayed in the center, among the one or more modes 2220, 2221, and 2222.

According to an embodiment, the external display device may display the one or more modes 2220, 2221, and 2222 to be aligned horizontally (or vertically or to overlap each other). According to an embodiment, the display device may display the second mode 2221 in the center by performing a swipe operation 2230 in the right direction while the first mode 2220 is being displayed in the center. According to an embodiment, the display device may display the third mode 2222 in the center by performing a swipe operation 2231 in the left direction while the first mode 2220 is being displayed in the center.

According to an embodiment, the external display device may display one or more functions included in one mode, as shown in FIG. 22B below, based on receiving a user input for selecting one mode from a list.

FIG. 22B is a diagram illustrating an example operation in which one mode is selected from a mode list of an external display device according to various embodiments.

Referring to FIG. 22B, if one of the one or more modes 2220, 2221, and 2222 is selected in the external display device, one or more functions and/or content included in the selected mode may be displayed.

For example, if a work mode is selected from the one or more modes 2220, 2221, and 2222 in the external display device, the region where the work mode is displayed may be expanded, and widget 2240, 2241, 2242 (e.g., a calendar widget, a map widget, or an email widget) of one or more functions included in the work mode may be displayed.

According to an embodiment, if a user input for selecting one of the widgets 2240, 2241, 2242 of the one or more functions is received, the external display device may display an execution screen of an application related to the selected widget, as illustrated in FIG. 22C below.

FIG. 22C is a diagram illustrating an example operation when one of the functions is selected in a mode of an external display device according to various embodiments.

Referring to FIG. 22C, if a user input 2250 for selecting one 2242 of the widgets of the one or more functions is received, the external display device may display content 2260 related to the widget. For example, if a widget is selected on the electronic device, the external display device may display the selected content in an immersive manner to the user in an XR environment, in the same way as displaying an execution screen of an application corresponding to the widget.

According to an embodiment, based on receiving a user input for executing one function of the one or more functions, the external display device may request content related to the one function from the electronic device. According to an embodiment, the external display device may display content related to the one function, based on receiving content related to one function from the electronic device.

According to an embodiment, based on receiving a user input for executing one function among the one or more functions, the external display device may identify whether an application related to the one function is stored in the memory of the external display device. According to an embodiment, based on identifying that an application related to the one function is stored in the memory, the external display device may display an execution screen of an application related to the one function.

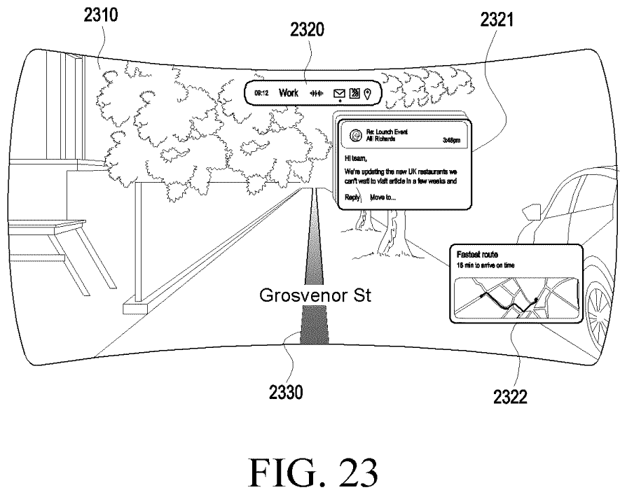

FIG. 23 is a diagram illustrating an example operation for displaying an execution screen of at least one function included in a mode of an external display device according to various embodiments.

Referring to FIG. 23, an external display device (e.g., the electronic device 104 in FIG. 1, the wearable electronic device 200 in FIG. 2, the wearable electronic device 300 in FIG. 3A or FIG. 3B, or the electronic device 400 in FIG. 4) may display a screen 2310 including a mode, as a small type 2320, received from an electronic device (e.g., the electronic device 101 in FIG. 1).

According to an embodiment, the small type 2320 of the mode may be provided at the top of the screen 2310 and may include only a mode name and an icon related to functions included in the mode.

According to an embodiment, the external display device may display widgets 2321 and 2322 of one or more functions included in the mode on a portion of the screen 2310.

According to an embodiment, the external display device may display, together with the widgets 2321 and 2322 of one or more functions included in the mode, a UI 2330 related to one function among the widgets 2321 and 2322 of one or more functions. For example, the external display device may display a guide line 2330 guiding a route, together with the widget 2322 of a map application related to route provision.

As described above, even when the user is moving while looking ahead without looking at the phone, the user may be continuously provided with the content provided by the electronic device in a familiar form and structure on the external display device.

According to an embodiment, the external display device may display an execution screen of the function included in the one or more modes, based on arrangement information of an execution screen of the function included in the one or more modes, which is included in the information related to the one or more modes. For example, a function may be disposed in different areas, even for the same function, between the modes in the external display device. For example, if each of the work mode and the health mode includes a calendar application, the execution screen of the calendar application may be disposed largely in the center of the screen of the external display device for identifying the schedule in the work mode, whereas it may be disposed small on one side of the screen of the external display device so as not to disturb exercise in the health mode.

According to an embodiment, the external display device may enter the mode selection state illustrated in FIG. 22A after selecting a small type 2320 of the mode at the top of the screen 2310, and may switch to another mode.

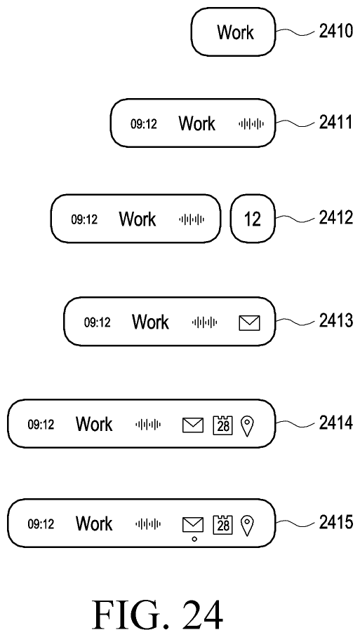

FIG. 24 is a diagram illustrating an example type of a mode list of an external display device according to various embodiments.

Referring to FIG. 24, an external display device (e.g., the electronic device 104 in FIG. 1, the wearable electronic device 200 in FIG. 2, the wearable electronic device 300 in FIG. 3A or FIG. 3B, or the electronic device 400 in FIG. 4) may display the mode in various types.

According to an embodiment, a first type 2410 of mode, which is the minimum type, may include only a mode name.

According to an embodiment, a second type 2411 of mode may include a mode name, time information, and information on whether to play music.

According to an embodiment, a third type 2412 of mode may further include the number of notifications, in addition to the second type 2411.

According to an embodiment, a fourth type 2413 of mode may further include an icon for one of a plurality of functions, in addition to the second type 2411.

According to an embodiment, a fifth type 2414 of mode may further include a plurality of icons related to the plurality of functions, in addition to the second type 2411.

According to an embodiment, a sixth type 2415 of mode may further include an indicator indicating the application where a notification occurred, in addition to the fifth type 2414.

According to an example embodiment, an electronic device (e.g., the electronic device 101 in FIG. 1) may include a display (e.g., the display module 160 in FIG. 1), a communication module (e.g., the communication module 190 in FIG. 1), comprising communication circuitry, memory (e.g., the memory 130 in FIG. 1), and at least one processor, comprising processing circuitry (e.g., the processor 120 in FIG. 1), operatively connected to the display, the communication module, and the memory.

According to an example embodiment, at least one processor, individually and/or collectively, may be configured to cause the electronic device to identify that it is connected to an external display device (e.g., the electronic device 104 in FIG. 1) through the communication module.

According to an example embodiment, at least one processor, individually and/or collectively, may be configured to cause the electronic device to: display information related to one or more modes including one or more functions and stored in the memory on the display.

According to an example embodiment, at least one processor, individually and/or collectively, may be configured to cause the electronic device to receive an input for transmitting the information related to the one or more modes to the external display device.

According to an example embodiment, at least one processor, individually and/or collectively, based on the input, may be configured to cause the electronic device to transmit the information related to the one or more modes to the external display.

According to an example embodiment, at least one processor, individually and/or collectively, may cause the electronic device to classify the one or more functions into the one or more modes, based on a type of an application stored in the electronic device, which is related to the function of the electronic device.

According to an example embodiment, at least one processor, individually and/or collectively, may be configured to cause the electronic device to classify the one or more functions into the one or more modes, based on a usage history of the one or more functions.

According to an example embodiment, the information related to the one or more modes may include at least one of identification information of the one or more modes, function information included in each of the one or more modes, or content related to the function.

According to an example embodiment, the information related to the one or more modes may include arrangement information of an execution screen of a function included in the one or more modes.

According to an example embodiment, the information related to the one or more modes may include at least one of the identification information of the one or more modes or the function information included in each of the one or more modes.

According to an example embodiment, at least one processor, individually and/or collectively, based on receiving a request for content related to one function among the one or more functions from the external display device, may be configured to cause the electronic device to transmit content related to the one function to the external display device.

According to an example embodiment, at least one processor, individually and/or collectively, based on identifying a connection with the external display device through the communication module, may be configured to cause the electronic device to display a message for identifying whether to display an execution screen of a function of the electronic device on the external display device.

According to an example embodiment, at least one processor, individually and/or collectively, based on receiving a user input for displaying the execution screen of the function of the electronic device on the external display device through the message, may be configured to cause the electronic device to display a list including the one or more modes.

According to an example embodiment, the external display device may include a wearable electronic device.

According to an example embodiment, a display device may include a display, a communication module, comprising communication circuitry, and at least one processor, comprising processing circuitry, operatively connected to the display and the communication module.

According to an example embodiment, at least one processor, individually and/or collectively, may be configured to cause the display device to receive information related to one or more modes respectively including one or more functions from an external electronic device through the communication module.

According to an example embodiment, at least one processor, individually and/or collectively, may be configured to cause the display device to display a list including the one or more modes on the display.

According to an example embodiment, at least one processor, individually and/or collectively, based on receiving an input for selecting one mode from the list, may be configured to cause the display device to display one or more functions included in the one mode.

According to an example embodiment, at least one processor, individually and/or collectively, based on receiving an input for executing one function among the one or more functions, may be configured to cause the display device to request content related to the one function from the external electronic device.

According to an example embodiment, at least one processor, individually and/or collectively, based on receiving content related to the one function from the external electronic device, may be configured to cause the display device to display the content related to the one function.

According to an example embodiment, the display device may further include memory.

According to an example embodiment, at least one processor, individually and/or collectively, based on receiving an input for executing one function among the one or more functions, may be configured to cause the display device to identify whether an application related to the one function is stored in the memory.

According to an example embodiment, at least one processor, individually and/or collectively, based on identifying that the application related to the one function is stored in the memory, may be configured to cause the display device to display an execution screen of the application related to the one function.

According to an example embodiment, at least one processor, individually and/or collectively, based on arrangement information of an execution screen of a function included in the one or more modes, included in the information related to the one or more modes, may be configured to cause the display device to display the execution screen of the function included in the one or more modes.

According to an example embodiment, a method of controlling include identifying a connection with an external display device.

According to an example embodiment, the method may include displaying information related to one or more modes including one or more functions and stored in memory of the electronic device.

According to an example embodiment, the method may include receiving an input for transmitting the information related to the one or more modes to the external display device.

According to an example embodiment, the method may include, based on the input, transmitting the information related to the one or more modes to the external display.

According to an example embodiment, the method may further include classifying the one or more functions into the one or more modes, based on a type of an application stored in the electronic device, related to the function of the electronic device.

According to an example embodiment, the method may further include classifying the one or more functions into the one or more modes, based on a usage history of the one or more functions.

According to an example embodiment, the information related to the one or more modes may include at least one of identification information of the one or more modes, function information included in each of the one or more modes, or content related to the function.

According to an example embodiment, the information related to the one or more modes may include arrangement information of an execution screen of a function included in the one or more modes.

According to an example embodiment, the information related to the one or more modes may include at least one of the identification information of the one or more modes or the function information included in each of the one or more modes.

According to an example embodiment, the transmitting of the information to the external display may include, based on receiving a request for content related to one function among the one or more functions from the external display device, transmitting content related to the one function to the external display device.

According to an example embodiment, the method may further include, based on identifying a connection with the external display device, displaying a message for identifying whether to display an execution screen of a function of the electronic device on the external display device,

According to an example embodiment, the method may further include, based on receiving an input for displaying the execution screen of the function of the electronic device on the external display device through the message, displaying a list including the one or more modes.

According to an example embodiment, a non-transitory computer-readable recording medium may store one or more programs, and the one or more programs may include instructions that, when executed by at least one processor, comprising processing circuitry, individually and/or collectively, of an electronic device, cause the electronic device to identify a connection with an external display device through a communication module.

According to an example embodiment, the one or more programs may include instructions that, when executed, cause the electronic device to receive an input for transmitting, to the external display device, information related to one or more modes respectively including one or more functions and stored in memory.

According to an example embodiment, the one or more programs may include instructions that, when executed, cause the electronic device to transmit, based on the input, the information related to the one or more modes to the external display.

According to an example embodiment, a non-transitory computer-readable recording medium may store one or more programs, and the one or more programs may include instructions that, when executed by at least one processor, comprising processing circuitry, individually and/or collectively, of a display device, cause the display device to receive information related to one or more modes respectively including one or more functions from an external electronic device through a communication module.

According to an example embodiment, the one or more programs may include instructions that, when executed, cause the display device to display a list including the one or more modes on the display.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a display;
a communication module comprising communication circuitry;
memory storing instructions; and
at least one processor, comprising processing circuitry,
wherein at least one processor, individually and/or collectively, is configured to execute the instructions and to cause the electronic device to:
identify a connection with an external display device through the communication module;
display, on the display, information related to one or more modes comprising one or more functions and stored in the memory;
receive an input for transmitting the information related to the one or more modes to the external display device; and
based on the input, transmit the information related to the one or more modes to the external display.

2. The electronic device of claim 1,
wherein at least one processor, individually and/or collectively, is configured to cause the electronic device to classify the one or more functions into the one or more modes, based on a type of an application stored in the electronic device and related to the function of the electronic device.

3. The electronic device of claim 1,
wherein at least one processor, individually and/or collectively, is configured to cause the electronic device to classify the one or more functions into the one or more modes, based on a usage history of the one or more functions.

4. The electronic device of claim 1,
wherein the information related to the one or more modes comprises at least one of identification information of the one or more modes, function information included in each of the one or more modes, or content related to the function.

5. The electronic device of claim 4,
wherein the information related to the one or more modes comprises arrangement information of an execution screen of a function included in the one or more modes.

6. The electronic device of claim 1,
wherein the information related to the one or more modes comprises at least one of identification information of the one or more modes or function information included in each of the one or more modes, and
wherein at least one processor, individually and/or collectively, is configured to cause the electronic device to, based on receiving a request for content related to one function among the one or more functions from the external display device, transmit content related to the one function to the external display device.

7. The electronic device of claim 1,
wherein at least one processor, individually and/or collectively, is configured to cause the electronic device to:
based on identifying a connection with the external display device through the communication module, display a message for identifying whether to display an execution screen of a function of the electronic device on the external display device; and
based on receiving an input for displaying the execution screen of the function of the electronic device on the external display device through the message, display a list comprising the one or more modes.

8. The electronic device of claim 1,
wherein the external display device includes a wearable electronic device.

9. A display device comprising:
a display;
a communication module comprising communication circuitry;
memory configured to store instructions; and
at least one processor, comprising processing circuitry;
wherein at least one processor, individually and/or collectively, is configured to execute the instructions and to cause the display device to:
receive information related to one or more modes respectively comprising one or more functions from an external electronic device through the communication module; and
display a list comprising the one or more modes on the display.

10. The display device of claim 9,
wherein at least one processor, individually and/or collectively, is configured to cause the display device to, based on receiving an input for selecting one mode from the list, display one or more functions included in the one mode.

11. The display device of claim 10,
wherein at least one processor, individually and/or collectively, is configured to cause the display device to:
based on receiving an input for executing one function among the one or more functions, request content related to the one function from the external electronic device; and
based on receiving content related to the one function from the external electronic device, display the content related to the one function.

12. The display device of claim 10,
wherein at least one processor, individually and/or collectively, is configured to cause the display device to:
based on receiving an input for executing one function among the one or more functions, identify whether an application related to the one function is stored in the memory; and
based on identifying that the application related to the one function is stored in the memory, display an execution screen of the application related to the one function.

13. The display device of claim 9,
wherein at least one processor, individually and/or collectively, is configured to cause the display device to display, based on arrangement information of an execution screen of a function included in the one or more modes, the execution screen of the function included in the one or more modes, and
wherein the arrangement information is included in the information related to the one or more modes.

14. A method for controlling an electronic device, the method comprising:
identifying a connection with an external display device;
displaying information related to one or more modes comprising one or more functions and stored in memory of the electronic device;
receiving an input for transmitting the information related to the one or more modes to the external display device; and
based on the input, transmitting the information related to the one or more modes to the external display.

15. The method of claim 14,
further comprising classifying the one or more functions into the one or more modes, based on a type of an application stored in the electronic device, related to the function of the electronic device.

16. A non-transitory computer-readable storage medium storing instructions which, when executed by at least one processor of an electronic device individually and/or collectively, cause the electronic device to:
identify a connection with an external display device;
display information related to one or more modes comprising one or more functions and stored in memory of the electronic device;
receive an input for transmitting the information related to the one or more modes to the external display device; and
based on the input, transmit the information related to the one or more modes to the external display.

17. The non-transitory computer-readable storage medium of claim 16, wherein the instructions, when executed by the at least one processor individually or collectively, cause the electronic device to:
classify the one or more functions into the one or more modes, based on a type of an application stored in the electronic device and related to the function of the electronic device.
